(19) United States
(12) Patent Application Publication
(10) Pub. No.: US 2025/0219812 A1
(43) Pub. Date: Jul. 3, 2025

(54) THRESHOLD-OPTIMAL MULTI-PARTY COMPUTATION

(71) Applicant: nChain Licensing AG, Zug (CH)

(72) Inventors: Alexandru PAUNOIU, London (GB); Jack Owen DAVIES, London (GB); Wei ZHANG, London (GB); Michaella PETTIT, London (GB)

(21) Appl. No.: 18/850,526

(22) PCT Filed: Feb. 28, 2023
(86) PCT No.: PCT/EP2023/054910

§ 371 Date: Sep. 24, 2024

(30) Foreign Application Priority Data
Mar. 31, 2022 (GB) 2204627.0

(51) Int. Cl. H04L 9/08

(52) U.S. Cl. CPC H04L 9/085; H04L 9/0869; H04L 2209/46

(57) ABSTRACT

A computer-implemented method for performing a multi-party computation (MPC) protocol, comprising: obtaining a circuit representation of a computable function to be evaluated based on one or more first inputs to generate one or more outputs, wherein each first input is to be either specified or randomly generated; converting the circuit representation of the function to a multi-party representation; making the multi-party representation available to each party; executing each SSG by distributing the respective share of the respective secret to each respective party; obtaining a respective share of each output from at least a threshold number of parties, the threshold number corresponding to a circuit threshold associated with the multi-party circuit; and generating each output of the function, wherein each output is generated based on at least the threshold number of the respective output shares of that output.

### CROSS REFERENCE TO RELATED APPLICATIONS

This application is the U.S. National Stage of International Application No. PCT/EP2023/054910 filed on Feb. 28, 2023, which claims the benefit of United Kingdom Patent Application No. 2204627.0, filed on Mar. 31, 2022, the contents of which are incorporated herein by reference in their entireties.

### TECHNICAL FIELD

The present disclosure relates to methods of performing multi-party computation.

### BACKGROUND

Multi-party computation (MPC) protocols were introduced by A. Yao in his seminal work Protocols for Secure Computations. The problem he solved was the Millionaires' Problem, whereby two millionaires wish to find who is richer without sharing information about their own wealth. This communication protocol led to the development of the rich field of secure multi-party computations (also sometimes referred to as SMPC): given a set of secret values held by several parties, combine this information in order to obtain some desired result without giving away any information about the secret values beyond what is inferred from the outputs.

MPC protocols typically use secret sharing methods to share the input data amongst the parties involved, and a protocol is then used to evaluate each gate. Secret sharing allows one to distribute a secret among a number of parties by distributing shares to each party. One example of such a scheme is Shamir's secret sharing scheme. Secret sharing schemes can tolerate an adversary controlling up to t parties out of n total parties, where t varies based on the scheme, the adversary can be passive or active, and different assumptions are made on the power of the adversary. In these MPC protocols, the function is defined by a circuit over a finite field. In such a circuit, the shared values are operated on are defined over a finite field.

Computable functions are functions for which there exists an algorithm that, when given the same inputs to the function, produces the same outputs. Any computable function can be expressed as a “circuit”. A circuit is a directed graph where the vertices are either inputs, outputs or gates, and the directed edges define the order of operations. The circuit (sometimes called an arithmetic circuit) comprises gates configured to perform an arithmetic operation, such as addition, multiplication, and so on.

### SUMMARY

A problem with current MPC protocols is that the threshold of one or more of the inputs to the function may differ from the threshold of one or more of the outputs of the function. That is, the threshold of the input(s) may change as they are operated on by the gates of the circuit. These MPC protocols lack threshold optimality.

The present disclosure describes a novel MPC protocol which achieves threshold optimality, meaning that the number of shares required to construct at least some (or each) input is the same as the number of shares required to construct each output. This novel MPC protocol is considered as a ‘threshold’ MPC protocol, meaning that it is robust against parties that want to either gain information or corrupt the evaluation of the computation, i.e. malicious parties.

According to one aspect disclosed herein, there is provided a computer-implemented method for performing a multi-party computation (MPC) protocol, wherein a group comprises a coordinator and a plurality of parties, and wherein the method is performed by the coordinator and comprises:
obtaining a circuit representation of a computable function to be evaluated based on one or more first inputs to generate one or more outputs, wherein each first input is to be either specified or randomly generated, and wherein the circuit representation comprises a) a plurality of arithmetic gates representing respective functions for operating on one or more of the first inputs and/or or one or more second inputs, wherein a second input is a respective output of a respective gate, and b) a plurality of directed edges, wherein each directed edge represents a first or second input being supplied to a respective arithmetic gate to be operated on by that respective arithmetic gate;
converting the circuit representation of the function to a multi-party representation of the function by:
   replacing each specified first input with a respective first splitting gate (SSG), wherein each respective SSG represents a protocol performed by the coordinator to distribute a respective share of a respective secret to each respective party, wherein the respective secret is associated with a respective threshold;
   replacing each randomly generated first input with a respective second splitting gate (JSG), wherein each respective JSG gate represents a protocol performed by each party to collaboratively generate a respective share of a respective secret, wherein the respective secret is associated with a respective threshold;
making the multi-party representation available to each party, wherein each party is configured to evaluate the function by executing the multi-party representation based on their respective shares of the respective secrets, thereby generating a respective share of each output;
executing each SSG by distributing the respective share of the respective secret to each respective party;
obtaining a respective share of each output from at least a threshold number of parties, the threshold number corresponding to a circuit threshold associated with the multi-party circuit; and
generating each output of the function, wherein each output is generated based on at least the threshold number of the respective output shares of that output.

The “multi-party circuit representation” may also be referred to as a “threshold circuit representation”, a “MPC circuit representation”, an “alternative circuit representation” or a “meta-circuit representation”.

In embodiments, said converting comprises inserting at least one share-redistribution gate (SRG), wherein each respective SRG represents a protocol performed by each party to collaboratively generate a new respective share of a respective shared value input to the respective SRG, wherein the new respective share is associated with the circuit threshold, whereas the respective shared value is associated with a higher threshold.

According to another aspect disclosed herein, there is provided a computer-implemented method of performing a multi-party computation (MPC) protocol, wherein a group comprises a coordinator and a plurality of parties, and wherein the method is performed by a first one of the parties and comprises:
obtaining a multi-party circuit representation of a computable function converted from a circuit representation of the function, wherein the function is to be evaluated based on one or more first inputs to generate one or more outputs, wherein each first input is to be either specified or randomly generated, and wherein the circuit representation comprises a) a plurality of arithmetic gates representing respective functions for operating on one or more of the first inputs and/or or one or more second inputs, wherein a second input is a respective output of a respective gate, and b) a plurality of directed edges, wherein each directed edge represents a first or second input being supplied to a respective arithmetic gate to be operated on by that respective arithmetic gate, and wherein the multi-party circuit is generated by:
   replacing each specified first input with a respective first splitting gate (SSG), wherein each respective SSG represents a protocol performed by the coordinator to distribute a respective share of a respective secret to each respective party, wherein the respective secret is associated with a respective threshold; and
   replacing each randomly generated first input with a respective second splitting gate (JSG), wherein each respective JSG gate represents a protocol performed by each party to collaboratively generate a respective share of a respective secret, wherein the respective secret is associated with a respective threshold;
evaluating the function by executing the multi-party circuit representation based on a first respective share of each respective secret to generate a first respective share of each output; and
sending the first respective share of each output to the coordinator, wherein the coordinator is configured to obtain a respective share of each output from at least a threshold number of parties, the threshold number corresponding to the circuit threshold, and to generate each output of the function, wherein each output is generated based on at least the threshold number of the respective output shares of that output.

The MPC protocol involves converting a circuit that defines a computational function into an alternative circuit representation, referred to herein as a “multi-party” circuit, or a “meta-circuit”. The term “meta-circuit” is used herein to refer to a new circuit that is based on and converted from the original circuit using the operations described herein. It is “multi-party” in the sense that it is to be evaluated by multiple parties. In particular, each input to the original circuit is replaced with a splitting gate that represents a secret sharing scheme used to distribute (e.g. Shamir's secret sharing scheme) or generate (e.g. a joint random secret sharing scheme) shares of the input. The meta-circuit is associated with a circuit threshold. The threshold of each output is the same as the circuit threshold. This means that the number of shares of each output required to reconstruct that output corresponds to the circuit threshold. The meta-circuit is similar to a conventional circuit in that it comprises gates (each representing a function, protocol, operation, etc.) and directed edges that represent the order of operations and flow of data into the gates.

The meta-circuit is generated by a coordinator who has access to (e.g. generates) the original circuit that represents the computable function. The coordinator may be one of the parties. The coordinator sends the meta-circuit to the parties. In other embodiments, each party may independently generate the meta-circuit. For each splitting gate in the meta-circuit, the parties either receive a respective share of a respective secret input value from the coordinator, or collaborating generate respective shares of a respective secret input value. The parties execute the meta-circuit and by doing so each generate a respective share of one or more outputs. Each party sends the respective output shares to the coordinator, who then constructs each output using (at least) the threshold number of shares. In this way, the threshold of each output is the same as the threshold of each input—the circuit threshold.

In general the MPC protocol described herein may be used to evaluate any computable function. For instance, the MPC protocol may be used to generate digital threshold signatures, e.g. threshold ECDSA signatures, with revealing the corresponding private key. As another example, the MPC protocol may be used to verify a person's age (or other personal data) without revealing the person's age (or other personal data).

Computing meta-circuits in an MPC setting allows a computation to be distributed or outsourced to a network of parties, rather than being performed by a single central party. Transforming these computations to a meta-circuit may introduce more complexity than computing by a single party, but there are at least four distinct advantages of outsourcing the computation in this manner.

One benefit of outsourcing these computations in many cases is to provide redundancy in processors (for computations) or storage (for storing shares), such that there is no single point of failure in the system overall. The coordinator may therefore set up an MPC network of parties for his computation, such that he may delete sensitive inputs and rely on the network to collectively store and reconstruct them.

A further benefit of instantiating such an MPC system is that it allows computations to be performed on data in a privacy-preserving manner. For instance, if the coordinator wants a computation executed on his data, but does not want to share or reveal his data to any third party, then he may establish an MPC network to perform the computation. In this way, his private data can be encoded as secret inputs, such that the computation can be performed without any single participant being able to determine the private data.

A scenario for outsourcing a particular computation may be where the network itself represents a set of interested parties (e.g. a collective of academic institutions), and the role of the ‘coordinator’ is interpreted as a data-provider to the network. In this case, the coordinator may not necessarily care about the result of the calculation, but the network requires some third party injection of data that is unknown to them. This motivates the MPC network requesting data from the coordinator as, for example, a source of randomness for a computation, and the coordinator may be rewarding for providing this data.

Moreover, if the coordinator does not have sufficient computational power to execute a circuit and wants to outsource its computation to a powerful network while benefitting from their computation being private, it can use the disclosed MPC protocol to have the function computed.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of an example system for implementing an MPC protocol,

FIG. 2 illustrates a standard circuit (LHS) and a meta-circuit (RHS) corresponding to the function ƒ(x,a,b)=ax+b,

FIG. 3 illustrates a standard circuit (LHS) and a meta-circuit (RHS) corresponding to the function ƒ(x,y)=XOR(x,y),

FIG. 4 illustrates a standard circuit (LHS) and a meta-circuit (RHS) corresponding to the function s(a,k)=k⁻¹e+k⁻¹ar,

FIG. 5 illustrates two meta-circuit representations of the function ƒ(x,y,a,b,c).

FIG. 6 schematically illustrates the verification of the reconstruction gate from the perspective of party i,

FIG. 7 shows a flow-diagram for the evaluation of an XOR circuit,

FIG. 8 illustrates a meta-circuit representation of threshold t_{c} of the V operator, and

FIG. 9 illustrates a meta-circuit representation of an age verification function.

### DETAILED DESCRIPTION OF EMBODIMENTS

### 1. Cryptographic Techniques

### 1.1 Elliptic Curves

The techniques described herein may use elliptic curves (ECs) of the form

$${y}^{2} = {x}^{3} + ax + b mod p$$

over prime fields Fp, with Δ:=−16(4a³+27b²)≠0 mod p. An example of such a curve is secp256k1 which is used in Bitcoin®. The order of this curve is denoted herein by n.

The multiplication of a point G on the elliptic curve by a∈Zₙ is denoted by the operator ‘·’ and defined as:

$$a \cdot G = G + G + … G$$

where ‘+’ here denotes elliptic curve point addition. Multiplication can therefore be understood as elliptic curve point addition of G with itself a times.

Note that the mod n notation will be omitted from now from now on, and it is assumed that all arithmetic operations over integers are done modulo n. Moreover, it will be understood that this is merely one example elliptic curve, and in general G may be a point on any curve where it is possible to compute a·G without easily finding a from the result.

### 1.2 Secret Sharing Schemes

This section describes how a secret S can be split between N participants, each holding a share of the secret. The secret S can be reconstructured with more than t shares. More precisely, the ‘threshold’ t of a shared secret S is the largest number of secret shares that does not allow the secret to be reconstructed.

### 1.2.1 Shamir Secret Sharing Scheme (SSSS)

In 1979, Shamir established a method to split a secret S into N shares, using a degree t polynomial, such that S may be reconstructed given at least t+1 unique points on the polynomial, where t+1≤N. This method is summarised below.

Assume we have a secret S. Define a random degree t polynomial with coefficients in [symbol] ₙ:

$$f ( x ) = {β}_{0} + {β}_{1} x + … + {β}_{t} {x}^{t} ,$$

where β₀=S, and the remaining coefficients βⱼ are some arbitrary constants. We can now use this polynomial to determine the N shares.

We label N points in a 2-dimensional space by:

$$( {x}_{1} , {a}_{1} ) , ... , ( {x}_{N} , {a}_{N} ) ,$$

where the x-coordinates are all distinct and non-zero. We choose xᵢ=i for i=1, . . . , N, then the y-coordinates satisfy:

aᵢ=ƒ(i),

for all integers i=1, . . . , N. The N pieces of data a₁, . . . , a_{N} represent the secret shares. We say the secret S is of threshold t. A coordinator that knows the secret S can then send each secret aᵢ to party i.

The secret S can be reconstructed from at least t+1 shares using the method of Lagrange interpolation as outlined further below.

### 1.2.2 Joint Verifiable Random Secret Sharing (JVRSS)

We now detail Feldman's protocol for Joint Verifiable Random Secret Sharing (JVRSS), which is used for defining and sharing a secret amongst multiple participants without a coordinator.

Assume that N participants want to create a joint randomly-distributed secret that can only be regenerated by at least (t+1) of the participants in the scheme. To create the shared secret of threshold t, the following steps are taken.
1. The participants agree on the unique label i for each participant. Each participant i generates t+1 random numbers

$${β}_{ij} {∈}_{R} {ℤ}_{n} \backslash \{ 0 \} , ∀ j = 0 , ... , t ,$$

where ε_{R} means a randomly generated element of [symbol] ₙ\{0}. Then each participant i has their own secret polynomial of degree t

$${f}_{i} ( x ) = {β}_{i 0} + {β}_{i 1} x + … + {β}_{it} {x}^{t} ,$$

for i=1, . . . , N.

These secret polynomials ƒᵢ(x) collectively define a shared secret polynomial as

$$f ( x ) = {\sum }_{j = 1}^{N} {f}_{i} ( x )$$

where the shared secret is given by S=ƒ(0).
2. Each participant i sends the value ƒᵢ(j) to participant j using a secure communication channel with participant j only.
3. Each participant i calculates their own private secret share of a shared secret polynomial as

$${a}_{i} := {\sum }_{j = 1}^{N} {f}_{j} ( i ) = f ( i ) .$$

4. Each participant i broadcasts the obfuscated coefficients βᵢₖ·G,
for k=0, . . . , t, and where G is the generator point of an EC group of order n.
5. Each participant i checks that each participant j has correctly calculated the polynomial point ƒⱼ(i) by calculating ƒⱼ(i)·G and verifying that

$${f}_{j} ( i ) \cdot G {=}^{?} {\sum }_{k = 0}^{t} {i}^{k} ( {β}_{jk} \cdot G ) ∀ j = 1 , … , N .$$

If all participants find that this equation holds for each polynomial, then the group can collectively be sure that they have all created the same shared polynomial.

In the secret-generation algorithm shown above, notice that steps 4 and 5 are related specifically to the verifiability aspect of the JVRSS scheme. These verification steps may be omitted if the situation is appropriate. An example would be where the ‘participants’ are all trusted. For cases such as these, we define two notions:
JRSS—the process of executing steps 1-3 of the above algorithm. This can be used in a trusted environment. No verification of the generated secret shares occurs.
JVRSS—the process of executing all steps 1-5 of the above algorithm. This requires no trust between parties, as the private secret shares are explicitly verified.

### 1.2.3 Reconstructing the Secret

With a subset of any t+1 of the shares aᵢ and the corresponding index i, the unique polynomial ƒ(x) can be calculated using Lagrange interpolation

$$f ( x ) = ( {\sum }_{l = 1}^{t + 1} {a}_{l} {\prod }_{1 \leq j \leq t + 1 , j \neq l} ( x - j ) \cdot {( l - j )}^{- 1} ) ,$$

To compute S=a₀ we evaluate ƒ at the point x=0:

$$S = f ( 0 ) = ( {\sum }_{l = 1}^{t + 1} {a}_{l} {\prod }_{1 \leq j \leq t + 1 , j \neq l} ( - j ) \cdot {( l - j )}^{- 1} ) .$$

We write the above equation as S=interpolate(a₁, . . . , aₜ₊₁). Note that with fewer than t+1 of these shares, there is not enough information to reconstruct a unique polynomial of degree t.

### 1.3 Operations on Shared Values

Arithmetic operations may be computed on shared values (or secrets if not disclosed) such as addition, multiplication and multiplicative inverse in the finite field [symbol] ₙ.

### 1.3.1 Addition of Shared Values

Assume two values, a of threshold tₐ and b of threshold t_{b}, are shared amongst a group of N participants and each participant i has shares aᵢ and bᵢ. To compute the addition of a and b, each participant i calculates their own additive share vᵢ=aᵢ+bᵢ corresponding to the shared value a+b of threshold max (tₐ, t_{b}).

The threshold max (tₐ, t_{b}) represents the degree of the polynomial ƒ+g, where ƒ is the polynomial of degree tₐ associated with a and g is the polynomial of degree t_{b} associated with b.

### 1.3.2 Product of Shared Values

Assume two values—a of threshold tₐ and b of threshold t_{b}—are shared amongst a group of N participants and each participant i has a share aᵢ and bᵢ. To compute the multiplication of a and b, each participant i calculates their own multiplicative share vᵢ=aᵢbᵢ corresponding to the shared value ab of threshold tₐ+t_{b}.

The threshold tₐ+t_{b} represents the degree of the polynomial ƒg, where ƒ is the polynomial of degree tₐ associated with a and g is the polynomial of degree t_{b} associated with b.

### 1.3.3 Inverse of a Shared Value

In many cryptographic protocols, such as computing an ECDSA signature, it is necessary to compute the inverse of a given value. It follows that we must be able to find inverses of such values in the case where the values themselves are shared in an MPC setting. To calculate the inverse of a shared value a with threshold tₐ, the following steps are taken.
1. All participants compute a shared secret b with threshold tₐ using the JRSS or JVRSS protocol. Each participant i has a share bᵢ.
2. Each participant i broadcasts their share aᵢbᵢ to all participants.
3. Each participant i computes μ=ab=interpolate (aᵢbᵢ, aᵢ₊₁bᵢ₊₁, . . . , aᵢ₊₂ₜ_{ₐ}bᵢ₊₂ₜ_{ₐ}), where aᵢ₊₁, . . . , aᵢ₊₂ₜ_{ₐ} and bᵢ₊₁, . . . , bᵢ₊₂ₜ_{ₐ} are received from participants i+1, . . . , i+2tₐ.
4. Each participant calculates the modular inverse of μ which results in μ⁻¹=(ab)⁻¹.
5. Each participant i calculates their own inverse share by calculating aᵢ⁻¹=μ⁻¹bᵢ.

We call b a blinding shared secret. It is used to keep the share aᵢ hidden in step 2 and not reveal the secret a in step 3.

### 1.4 Shared Value Redistribution

This section describes how to redistribute shares aᵢ for a particular shared value a of threshold tₐ amongst the participants. This results in each participant generating a new share aᵢ′ corresponding to the same value a. The method is as follows:
1. All N participants of the new scheme generate a blinding share κᵢ with threshold t_{κ} using the JRSS or JVRSS protocol.
2. Each participant i computes the intermediary share vᵢ=aᵢ+κᵢ corresponding to the value a+κ of threshold max (tₐ, t_{κ}).
3. Each participant i broadcasts the intermediary shares to all participants.
4. All participants calculate the blinded value with (max(tₐ, t_{κ})+1) of the intermediary shares v=interpolate (v₁, . . . , vₘₐₓ₍ₜ_{ₐ}_{,t}_{_{κ}}₎₊₁)=a+κ.
5. Each participant calculates their own new share aᵢ′=v−κᵢ=(a+κ)−κᵢ corresponding to the value a of threshold t_{κ}.

### 2. Example System Overview

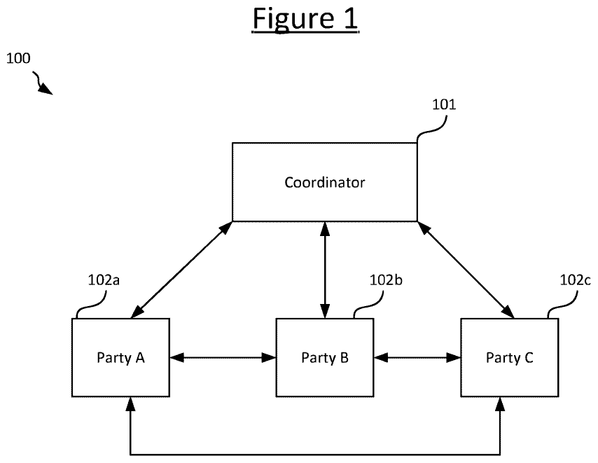

FIG. 1 shows an example system 100 for implementing the multi-party computation (MPC) protocol disclosed herein. The system comprises a coordinator (or coordinating party) 101 and one or more parties (or participants) 102. The coordinator 101 and each party 102 are connected such that can send and receive data. For instance, the parties may be connected over a packet-switched network, e.g. a wide-area internetwork such as the Internet. I

For simplicity, the coordinator 101 is described as being a separate entity to the parties. However in some examples the coordinator 101 is one of the parties 102 and any of the parties 102 may perform the role of the coordinator 101. That is, there may be at least one party 102 that performs both the functions attributed to the coordinator 101 and those attributed to the parties 102.

Three parties 102a, 102b, 102c are shown for illustrative purposes. It will be understood that the system 100 may comprise many more such parties present and participating in the system 100, but for convenience they are not illustrated. Each party 102 may be an individual, an organization, a machine, a server, etc. That is to say, a party 102 may take any suitable form, and is not necessarily a user or group of users, though that is not excluded.

The coordinator 101 and each party 102 operates respective computer equipment (not shown). The respective computer equipment of the coordinator 101 and each party 102 comprises respective processing apparatus comprising one or more processors, e.g. one or more CPUs, GPUs, other accelerator processors, application specific processors, and/or FPGAs. The respective computer equipment further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the respective computer equipment may store software comprising a respective instance of at least one client application arranged to run on the processing apparatus. It will be understood that any action attributed herein to the coordinator 101 or a given party 102 may be performed using the software run on the processing apparatus of the respective computer equipment. The respective computer equipment may comprise at least one user terminal, e.g. a desktop or laptop computer, a tablet, a smartphone, or a wearable device such as a smartwatch. The computer equipment may additionally or alternatively comprise one or more other networked resources, such as cloud computing resources accessed via the user terminal.

The client application may be initially provided to the computer equipment of any given party 102 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

### 3. Threshold-Optimal MPC

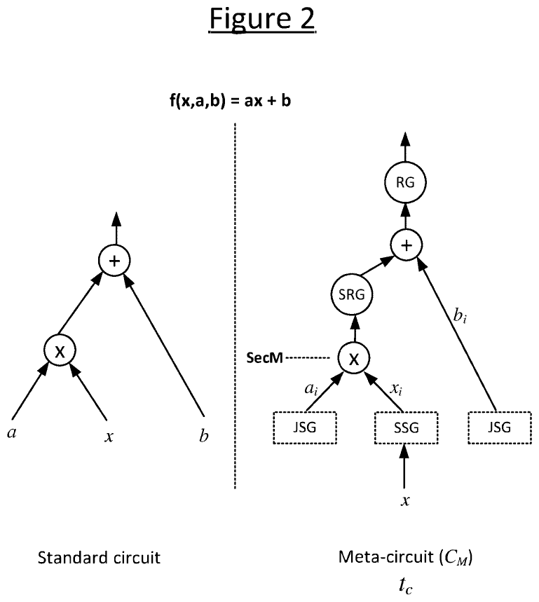

The coordinator 101 is configured to obtain a circuit representation (or expression) of a computable function. As mentioned above, computable functions are functions for which there exists an algorithm that, when given the same inputs to the function, produces the same outputs. One or more inputs may be specified by the coordinator. These are inputs for which the function is to be evaluated. One or more inputs may be randomly generated. For instance, these inputs may represent constants, or arbitrary values. A circuit is a directed graph where the vertices are either inputs, outputs or gates, and the directed edges define the order of operations. In conventional circuits, a gate represents an arithmetic operation, such as addition, multiplication, subtraction, division, inversion, etc. That is, each respective (arithmetic) gate may be one of i) an addition gate, ii) a subtraction gate, iii) a multiplication gate, iv) a division gate, or v) an inverse gate. The directed edges thus represent the flow of data input to a gate to be operated on. The circuit representation is referred to herein as the “standard circuit”, or “original circuit”. Examples of standard circuits is shown in FIGS. 2 to 4. Referring to FIG. 2, the function ax+b, has multiple input (x, a, b) and a single output ω₁=ƒ(x, a, b). The circuit comprise a multiplication gate configured to multiply the inputs x, a, and an addition gate configured to add the intermediate result ax with the input b.

In general the standard circuit may take any form. For instance, the standard circuit may be represented in code, in words, or even as a schematic diagram. Regardless of the particular format in which the standard circuit is expressed, the coordinator 101 is configured to interpret the features (i.e. gates and directed edges) of the standard circuit.

The coordinator 101 may generate the standard circuit based on the computable function. Alternatively, the coordinator 101 may obtain the standard circuit from another resource, such as a different coordinator, a website, memory, etc.

The coordinator 101 is configured to convert the standard circuit into a meta-circuit representation of the computable function. Similarly, any of the parties 102 may also be configured to convert the standard circuit into the meta-circuit. That is, the parties 102 may independently create the meta-circuit. As described later, conversion of the standard circuit to the meta-circuit may be performed by any party that knows the MPC protocol. Converting the standard circuit to the meta-circuit comprises a series of steps, some of which may be performed in any order. Note that the term “meta-circuit” is used merely as a label for the converted circuit, and the term “converted circuit”, or “modified circuit”, or “multi-party circuit”, or “alternative circuit” may be used instead.

Converting the standard circuit to the meta-circuit comprises replacing each input that is to be specified by the coordinator 101 with a respective first splitting gate. That is, each input of this type is replaced with its own first splitting gate. The first splitting gate represents a protocol to be performed by the coordinator 101 to generate respective shares of the corresponding input and distribute those shares to the parties, one to each party 102. Each input is a secret with a threshold. When the meta-circuit is executed, for each first splitting gate, the coordinator 101 is configured to generate and distribute shares of the corresponding secret to the parties 102. The protocol represented by the first splitting gate may be Shamir's secret sharing scheme (SSSS). Other dealer-based secret sharing schemes may be used instead.

Converting the standard circuit to the meta-circuit comprises replacing each input that is to be randomly generated with a respective second splitting gate. That is, each input of this type is replaced with its own second splitting gate. The second splitting gate represents a collaborative protocol to be performed by each party 102 to generate a respective share of the corresponding input. When the meta-circuit is executed, for each second splitting gate, the parties 102 are configured to collaborate to generate respective shares of the corresponding secret. The protocol represented by the second splitting gate may be the joint random secret sharing (JRSS) scheme or the joint verifiable random secret sharing (JVRSS) scheme. Other secret sharing schemes may be used instead.

In some examples, the threshold of each secret is the same. In other examples, one or more of the secrets may have different thresholds. The threshold of each individual secret may be less than, equal to, or greater than the circuit threshold. For instance, the circuit may involve two secrets with respective thresholds t_{A} and t_{B}. The circuit threshold is denoted by t_{C}. The secrets may satisfy the equation t_{A}, t_{B}≥t_{C} where t_{A}=t_{B} or where t_{A}≠t_{B}, including the case where t_{A}>t_{B}. Similarly, the case where t_{B}=t_{C} is not excluded.

The overall circuit is associated with a circuit threshold, as mentioned. The circuit threshold is the threshold of each output that is generated by the circuit, i.e. the threshold number of output shares required to generate each output.

As an example, the inputs (x, a, b) in the standard circuit of FIG. 2 are converted into first and second splitting gates of the corresponding meta-circuit. “SSG” indicates a first splitting gate and “JSG” indicates a second splitting gate.

Converting the standard circuit to the meta-circuit may comprise one or more additional steps, which are discussed below.

Once the meta-circuit is generated, the coordinator 101 sends the meta-circuit to each party 102. Like the standard circuit, the meta-circuit may take any suitable format, e.g. computer code, text, images, etc. Each party 102 is configured to execute the meta-circuit using the one or more respective shares that have been received from the coordinator 101 (corresponding to the first splitting gate(s)) and/or generated by the parties 102 (corresponding to the second splitting gate(s)). Each party 102 uses the gates and directed edges of the meta-circuit to execute the meta-circuit and generate respective shares of one or more outputs.

Each party 102 sends their respective shares of the one or more outputs to the coordinator 101. The coordinator 101 then generates each output based on at least the threshold number of shares of that output, e.g. by interpolating over the respective shares.

In some embodiments, converting the standard circuit to the meta-circuit comprises inserting one or more “reconstruction gates” into the meta-circuit. Each reconstruction gate represents a protocol performed by the coordinator 101 to generate an output by interpolating over the shares of the output that are supplied to the reconstruction gate, i.e. sent to the coordinator 101 by the parties. The meta-circuit may comprise a respective reconstruction gate for each output.

In some embodiments, the standard circuit comprises one or more inverse gates representing an operation to compute the inverse of a non-scalar input. In these embodiments, converting the standard circuit to the meta-circuit comprises replacing each inverse gate with a “share inverse gate”. Each share inverse gate represents a collaborative protocol performed by each party 102 to compute the inverse of a share that is supplied to the share inverse gate.

Converting the standard circuit to the meta-circuit may comprise inserting one or more “share-redistribution gates” (SRGs) into the meta-circuit. Each SRG represents a collaborative protocol performed by each party 102 to generate a new respective share of a shared value (i.e. shared secret) input to the SRG. That is, each participant 102 has a share of the shared value which is supplied to the SRG, and the protocol is configured to output a new share of the same shared value. The old share has a threshold higher than the new share. The threshold of the new share is the same as the circuit threshold. Each SRG may represent the protocol described above in section 1.4 Shared value redistribution.

SRGs may only be required if the circuit comprises one or more “share multiplication gates” configured to perform a multiplication operation on two shares suppled to the share multiplication gate.

There are several options for inserting SRGs into the meta-circuit. One option is to insert an SRG between each share multiplication gate and the next gate in the meta-circuit. An example of this option is shown in FIG. 2, where an SRG gate is inserted after the share multiplication gate (indicated by the label “SecM”) and the next gate, which is an addition gate in this example. The multiplication of the shares aᵢ and bᵢ would result in a result abᵢ having a higher threshold than aᵢ and bᵢ. The SRG gate produces a share of abᵢ having the same threshold as aᵢ and bᵢ.

As another option, rather than inserting an SRG after each share multiplication gate, the coordinator 101 may insert an SRG before a share multiplication gate if the input to that share multiplication gate is higher than the circuit threshold. In other words, an SRG is inserted between the previous gate and the share multiplication gate. In this option, the coordinator 101 also inserts an SRG before each reconstruction gate.

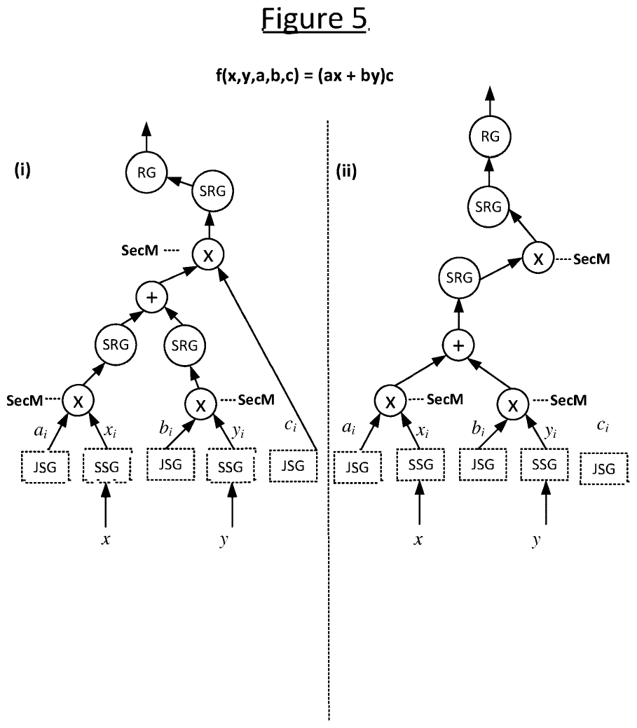

An example of these two options is shown in FIG. 5. On the left-hand side (LHS), an SRG gate is inserted after each share multiplication gate. This results in the meta-circuit having three SRGs, one for each share multiplication gate. In contrast, on the right-hand side (RHS), an SRG gate is inserted between an addition gate and a share multiplication gate, since the input to the share multiplication gate has a threshold higher than the circuit threshold. The higher threshold of the input is due to the multiplication of shares. An SRG is also inserted before the reconstruction gate. This results in the meta-circuit having two SRGs.

The following describes a third option for inserting SRGs. A maximum threshold circuit for the meta-circuit may be defined as 2t_{C}≤tₘₐₓ<N, where N is the number of parties in the group and t_{C} is the threshold of the respective secrets. If the meta-circuit comprises one or more share inverse gates, the coordinator 101 inserts an SRG between the input (i.e. the previous gate) to the share inverse gate and the share inverse gate if the share being supplied to the share inverse gate has a threshold of t>tₘₐₓ−t_{C}. In addition, if the threshold of a share output by a share multiplication gate is expected to be higher than tₘₐₓ, the coordinator 101 inserts an SRG between one of the inputs (i.e. previous gates) to the share multiplication gate and the share multiplication gate. An SRG is also inserted before each reconstruction gate.

There are scenarios where the coordinator 101 and/or the parties may wish to verify that the meta-circuit has been correctly evaluated, or that certain stages of the meta-circuit have been corrected evaluated. For instance, the parties 102 may wish to verify the shares distributed by the coordinator 101 as part of performing the protocol defined by the first splitting gate, e.g. SSSS. To do so, for each input, the coordinator 101 may send to the parties 102 the obfuscated coefficients of the polynomial associated with the input. Therefore each party 102 receives a respective share of the input and the obfuscated shares of all other participants. Each party 102 can verify their share based on the obfuscated shares of the other parties 102.

The parties 102 may also wish to verify the shares generated by the protocol defined by the second splitting gate. The parties may use the JVRSS to generate these shares, which involves the verification steps defined above in section 1.2.2.

Each party 102 may also wish to verify the shares of the output(s) that are generated by the other parties. E.g. party A 102a may wish to verify that party B 102b and party C have correctly evaluated the meta-circuit. To do so, each party 102 obtains the obfuscated input shares of each other party. Here, an obfuscated input share of a party means an obfuscated version of a share of the input generated by of distributed to that party. For example, if there are two inputs to the meta-circuit, each party obtains obfuscated shares of each of the two inputs for each other party 102. E.g. party A 102a obtains two obfuscated input shares for party B 102b and two obfuscated input shares for party C 102c. A share may be obfuscated by multiplication with the generator point, or in other suitable ways.

Each party 102 then evaluates the meta-circuit using the obfuscated input shares of a given party to generate obfuscated output shares of that party. For instance, party A 102a uses the obfuscated input shares of party B 102b to generate obfuscated output shares of party B 102b, and also uses the obfuscated input shares of party C 102c to generate obfuscated output shares of party C 102c. Evaluating the meta-circuit using the obfuscated input shares is done in the same way as a party 102 would evaluate the meta-circuit using their own non-obfuscated input shares, except that the obfuscated shares of a different party 102 are used instead. Depending on the gates in the meta-circuit, a party 102 may be required to send obfuscated versions of intermediate results of the computation to the other parties. Each party 102 may then generate obfuscated versions of each output based on the obfuscated shares of each output. Then, each party 102 verifies that the non-obfuscated output shares have been correctly calculated by comparing the output (generated based on the non-obfuscated shares that each party has generated using their non-obfuscated input shares) with the obfuscated output (generated by a given party for themselves and each other party).

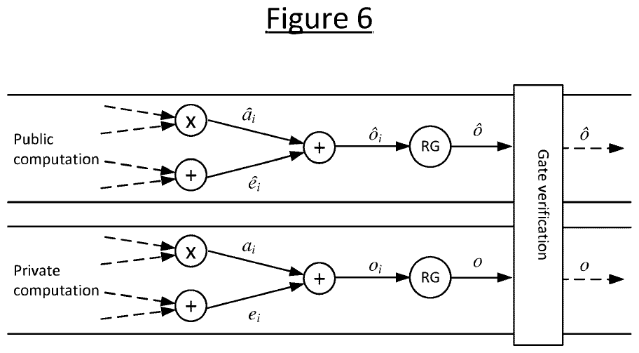

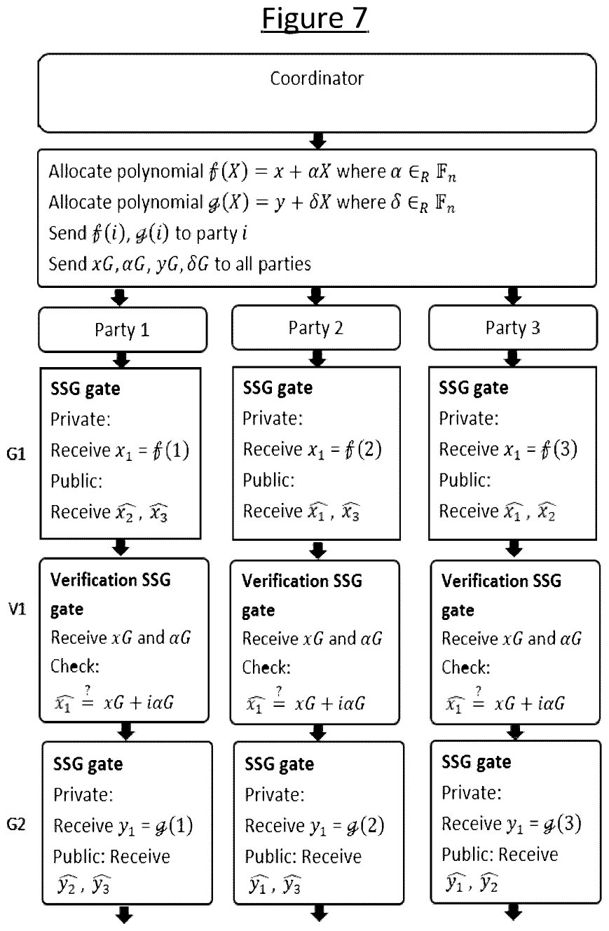

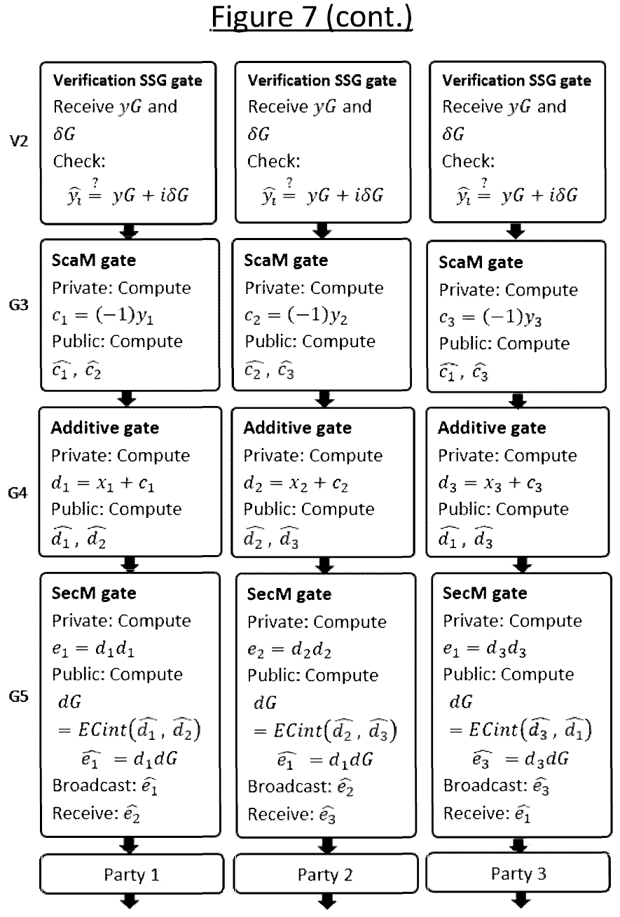

An example of this process is illustrated in FIG. 6. Each party 102 computes non-obfuscated output shares using the non-obfuscated input shares, with the non-obfuscated output shares being used to generate the non-obfuscated output of the meta-circuit. This is the “private computation” path. Each party 102 also computes obfuscated output shares using the obfuscated input shares of each other party, with the obfuscated output shares being used to generate the obfuscated output of the meta-circuit. This is the “public computation” path. The non-obfuscated output from the private computation path can be obfuscated and compared with the obfuscated output from the public computation path.

### 4. Efficient Threshold-Optimal MPC (ETOM)

This section describes a specific implementation of the MPC protocol described above. It is assumed that all N participants are honest and hence the circuit does not require any verification.

### 4.1 Meta-Circuit

As described above, given a circuit C, the coordinator 101 can convert it to a new representation that includes gates required to carry out the ETOM computation. Each of the inputs has the same threshold t_{C}. Even though during the Meta-Circuit computation the threshold may vary to some value t, the ETOM protocol ensures that the meta-circuit outputs are of threshold t_{C}.

The following describes example gates which the coordinator 101 may use to construct a meta-circuit.

### 4.1.1 Input Gates

In order to evaluate meta-circuits any inputs to the circuit are split appropriately amongst the participants of the ETOM scheme. There are two input types: dealt and random.

Therefore we introduce new associated circuit gates that split the inputs among participants:
Shamir-splitting gate (SSG)-through the SSG gate of threshold t_{C}, the coordinator deals the input a₀ to the participants. The gate executes SSSS, splitting the input into shares dᵢ and distributes them among participants. Each participant i receives a share aᵢ of a₀.

The SSG is an example of the first splitting gate described above.
JRSS-splitting gate (JSG)—through the JSG gate of threshold t_{C}, the participants execute JRSS (section 2.2.2). After each participant i creates their private polynomial ƒᵢ(x)=βᵢ₀+βᵢ₁x+ . . . +βᵢₜ_{_{C}}x^{t}^{_{C}}, all participants collaborate in order for each i participant to create a share aᵢ. The shares correspond to a value a. The JSG is an example of the second splitting gate described above.

### 4.1.2 Addition Gate

The addition gate takes two operands and adds them together to produce the output. In the context of ETOM, the operands can be either a scalar (constant values part of the, meta-circuit), or a share of a value. For example, in the case two operands a, b are shared values of thresholds tₐ and t_{b}, the addition gate outputs a+b, of threshold max (tₐ, t_{b}).

### 4.1.3 Multiplication Gates

A multiplication gate is a circuit gate which multiplies two operands and outputs the result. The multiplication of two shared values produces a new shared value that increases the threshold. Since this is the only gate that may increase the threshold, we differentiate between two settings as follows:
Scalar multiplication (ScaM) gates—takes one scalar value and one shared share as input and multiplies them. The output has the same threshold as the shared share.
Share multiplication (SecM) gates—takes shares of two different shared values as input and multiplies them. For example, in the case of two inputs a, b are shared values of thresholds tₐ and t_{b}, the SecM gate outputs ab, of threshold tₐ+t_{b}.

### 4.1.4 Reconstruction Gate (RG)

A reconstruction gate can be used by each participant to reconstruct a shared value of threshold t. It requires a participant to request at least t shares from t participants. Using its own share a₁ and the t received shares a₂, . . . , aₜ₊₁, it uses Lagrange interpolation to compute the shared value output a as detailed above. The gate calculates:

$$interpolate ( {a}_{1} , … , {a}_{t + 1} ) = a .$$

### 4.1.5 Share-Redistribution Gate (SRG)

This gate is used to reduce the threshold of a shared value. It takes as input a shared value of threshold t, applies the value redistribution scheme in section 1.4 and distributes a new shared value of threshold t_{C} amongst the ETOM participants. We recall that the value redistribution scheme uses the JRSS protocol, requiring all participants to communicate in order to create a blinding shared value.

Furthermore we can express the SRG gate in full granularity. If aᵢ is the input to the gate, then participant i executes the following steps, which collectively define an SRG:
1. JSG gate: βᵢ (share of participant i)
2. Additive gate: aᵢ+βᵢ
3. Reconstruction gate: a+β
4. ScaM gate: (−1)βᵢ
5. Additive gate: (a+B)+(−1)βᵢ

A practical example is to insert an SRG gate after a SecM gate. If the SecM gate outputs a shared value of threshold 2t_{C}, then we can reduce the threshold to t_{C}. This prevents the share of intermediate products in the circuit from blowing up.

### 4.1.6 Inverse Gates

These gates take as input one operand and output its additive or multiplicative inverse. The additive inverse can be computes with the following gate:
Additive inverse gate—takes as input a share aᵢ and outputs—aᵢ in the field [symbol] ₙ. This is equivalent to executing the ScaM gate with the scalar—1 as seen in step 4 of SRG. Because the inverse of shares of shared values need to be computed using the method outlined in section 1.3, we differentiate between inverting a scalar and inverting a share as follows:
Scalar inverse gate (Scl)—takes as input a scalar α and outputs α⁻¹ in the field [symbol] ₙ.
Share inverse gate (IVG)—takes as input a share αᵢ and executes the method in section 2.3 to output the inverse αᵢ⁻¹. We recall that to compute αᵢ⁻¹ all participants need to communicate and they create a blinding shared secret.

Furthermore we can express the IVG gate in full granularity. If αᵢ is the input to the gate, then participant i executes the following steps, which collectively define an IVG:
1. JSG gate: βᵢ (share of participant i)
2. SecM gate: αᵢβᵢ
3. Reconstruction gate: αβ
4. Scl gate: (αβ)⁻¹
5. ScaM gate: (αβ)⁻¹βᵢ

The output result of participant i is (αβ)⁻¹βᵢ corresponding to the shared value a.

### 4.2 ETOM Scheme

Consider a coordinator 101 who wishes to outsource the computation of a function to an ETOM network of peers 102. An example scheme specifying how the function can be evaluated by this network is as follows:
Input(s): Function=ƒ(x₁, x₂, x₃, . . . ), Inputs=(x₁, x₂, x₃, . . . )
Output(s): (ω₁, ω₂, ω₃, . . . )=ƒ(x₁, x₂, x₃, . . . )
   1. The coordinator 101 chooses a function ƒ(x₁, x₂, x₃, . . . ), and any dealt inputs (x₁, x₂, x₃, . . . ) for which the function is to be evaluated.
   2. The coordinator 101 creates the circuit representation C_{S} for ƒ.
   3. The coordinator 101 converts this circuit C_{S} into a Meta-circuit C_{M}. They do this by:
      a. Replacing each dealt input by an SSG to distribute the input;
      b. Replacing each random input by a JSG;
      c. Replacing each inverse gate for a non-scalar input with an IVG;
      d. Inserting an SRG between each SecM gate and its next gate.
   4. The coordinator 101 broadcasts the meta-circuit C_{M} and the circuit threshold t_{C} to all participants 102. Broadcasting may refer to publishing on a shared resource, e.g. a message bus.
   5. The coordinator 101 executes all input SSG gates.
   6. Each participant 102 evaluates the Meta-Circuit C_{M}.
   7. After evaluating the circuit, each participant i sends each output share(s) ωᵢₖ to the coordinator 101, where ωₖ denotes the k^{th} output of the circuit.
   8. The coordinator 101 performs Lagrange interpolation over t_{C}+1 output shares received to find the k^{th} output ωₖ of the computation. This is represented as a reconstruction gate (RG) in the meta-circuit.

### 4.3 Examples

Three worked examples are now provided: one covering a linear function, one showing how we can execute logic operators with ETOM, and one showing how an ECDSA threshold signature protocol can be modelled by ETOM.

We use variables x, y, z to denote dealt variables, which are converted into shared values using SSSS to be used in the rest of the circuit. Conversely, we use variables a, b, c to denote random inputs that are generated using JRSS.

### 4.3.1 Simple Algebraic Circuit

In this section we show how a simple linear function can be computed using meta-circuits. Consider the function ƒ(x, a, b)=ax+b, which takes a mix of dealt and random inputs, x and a, b, respectively. Because the function contains a multiplication of shared values, we assume that there are at least 2t_{C}+1 participants in the ETOM scheme and compute ƒ by following the protocol in section 4.2:
Inputs: Function=ax+b, Inputs=(x, a, b)
Output: ω₁=ƒ(x, a, b)
   1. The coordinator 101 chooses the function ax+b and the input x for which the function is to be evaluated.
   2. The coordinator 101 creates the circuit representation C_{S} for ƒ as seen in the LHS of FIG. 2.
   3. The coordinator 101 converts this circuit into a meta-circuit CM as seen in the RHS of FIG. 2:
      1. Replaces the input x by an SSG gate;
      2. Replaces the random inputs a, b by a JSG gate;
      3. Inserts an SRG gate after the (SecM) multiplication gate
   4. The coordinator 101 broadcasts the meta-circuit C_{M} and the circuit threshold t_{C} to all participants.
   5. The coordinator 101 executes the SSG gate.
   6. Each participant 102 evaluates the meta-circuit C_{M}.
   7. After evaluating the circuit, each participant 102 sends each output share to the coordinator.
   8. The coordinator 101 performs Lagrange interpolation over t_{C}+1 output shares received to find the result ω₁ of the computation.

We note that the SecM multiplication gate between the shares aᵢ and xᵢ of threshold t_{C} will produce an output share aᵢxᵢ of threshold 2t_{C} corresponding to the value ax. Thus, by executing the SRG gate, participant i lowers the threshold of aᵢxᵢ by computing a share oᵢ of threshold t_{C} corresponding to the value ax.

### 4.3.2 Boolean Circuits

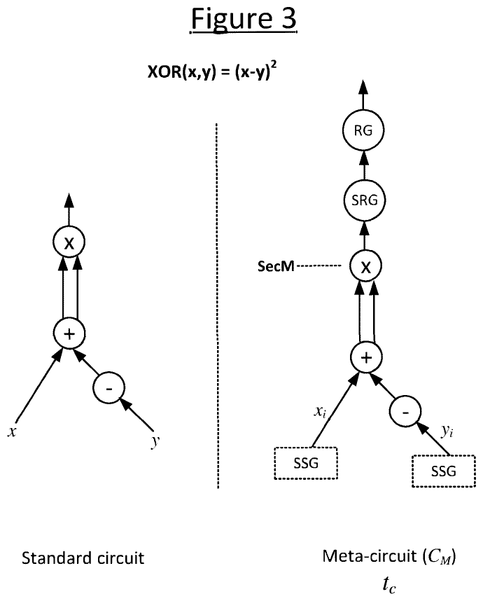

The next class of circuits we consider is the Boolean circuit, which can be used to describe the functions of logical operators such as AND, XOR, and NOT. It is important to consider such circuits, since any Turing machine can be computed using logical operators. In practice, computing units (e.g. CPU, GPU) are built up from circuits made out of logical operators. To construct Boolean Meta-Circuits we write the logical operators using addition and multiplication, and using the protocol in section 4.2, we obtain the meta-circuit. Consider, as an example the logical XOR function, which can be written algebraically as

$$f ( x , y ) = XOR ( x , y ) = {( x - y )}^{2} = ( x - y ) \cdot ( x - y )$$

where x and y values that are either 0 or 1. In terms of the ETOM language we have introduced in section 3.1 x and y are dealt inputs. As seen in the examples in section 4.3.1, because the function ƒ(x, y) is obtained using a multiplication, we assume that there are at least 2t_{C}+1 participants 102. Following the protocol in section 4.2, the coordinator 101 and participants execute the steps:
Inputs: Function=(x−y)², Inputs=(x, y)
Output: ω₁=ƒ(x, y)
   1. The coordinator 101 chooses the function ƒ(x, y), and the inputs x, y∈{0,1} on which the function is to be evaluated.
   2. The coordinator 101 creates the circuit representation C_{S} for ƒ as seen in the LHS of FIG. 3.
   3. The coordinator 101 converts this circuit into a meta-circuit C_{M} as in the RHS of FIG. 3:
      a. Replaces each dealt input x, y with SSG gates
      b. Inserts an SRG gate after each SecM gate.
   4. The coordinator 101 broadcasts the Meta-Circuit C_{M} and the circuit threshold t_{C} to all participants 102.
   5. The coordinator 101 executes the two SSG gates.
   6. Each participant 102 evaluates the meta-circuit C_{M}.
   7. After evaluating the circuit, each participant 102 sends each output share to the coordinator 101.
   8. The coordinator 101 performs Lagrange interpolation over t_{C}+1 output shares received to find the result ω₁ of the computation.

### 4.3.3 ECDSA

This example demonstrates how a threshold-optimal Elliptic Curve Digital Signature Algorithm (ECDSA) can be modelled as a specific case of the ETOMs scheme described in section 4.2. The following signature function, for a given message, takes a private key a and an ephemeral key k as inputs and produces the s-part of an ECDSA signature as output. We can write this function as

$$s ( a , k ) = {k}^{- 1} ( e + ar ) = {k}^{- 1} e + {k}^{- 1} ar$$

where e is the hash digest of the message to be signed, the r-part of the signature is defined as r=[k·G]ₓ, and all operations in the equation are performed modulo n.

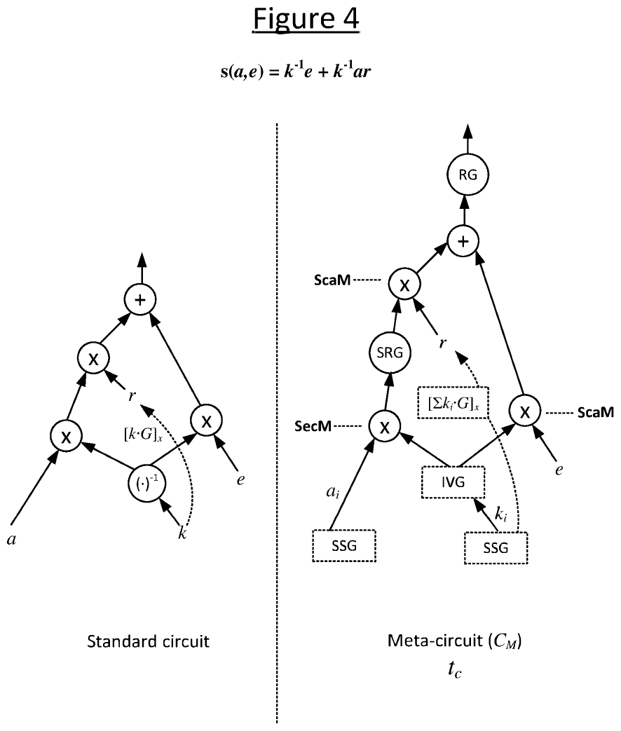

In the ETOM context, the private key a is a dealt input and the ephemeral key k is a random input. The steps of the protocol in section 4.2 are the following:
Inputs: Function=s(a, k), Inputs=(a, k)
Output: ω₁=s(a, k)
   1. The coordinator 101 chooses the function s(a, k), and dealt input a for which the function is to be evaluated.
   2. The coordinator 101 creates the circuit representation C_{S} for ƒ as seen in LHS of FIG. 4.
   3. The coordinator 101 converts this circuit into a meta-circuit C_{M} as in RHS of FIG. 4:
      a. Replaces the dealt input a by an SSG gate;
      b. Replaces the random input k by a JSG gate;
      c. Replaces the inverse gate with a non-scalar input with an IVG;
      d. Inserts an SRG between the SecM gate and its next gate.
   4. The coordinator 101 broadcasts the meta-circuit C_{M} and the circuit threshold t_{C} to all participants 102.
   5. The coordinator 101 executes all SSG gates.
   6. Each participant 102 evaluates the meta-circuit C_{M}.
   7. After evaluating the circuit, each participant 102 sends each output share to the coordinator 101.
   8. The coordinator 101 performs Lagrange interpolation over t_{C}+1 output shares received to find the output ω₁=s(a, k)=k⁻¹e+k⁻¹ar.

The bottom-left area of the meta-circuit in FIG. 4 represents the computation of the private key and may be precomputed once per scheme. The output of this circuit is the input to the circuit in the middle area. The middle area represents a pre-calculation phase computing the message-independent term k⁻¹ar. This may be precomputed once per signature. The signature generation phase is represented by the top-right area in FIG. 4 and computes the message-dependent term k⁻¹e. This is executed for every message.

### 4.4 Optimising Circuit Evaluation

Three strategies that can be employed to modify the ETOM protocol in order to reduce or optimise the overall computational overhead for evaluating a circuit are now described.

### 4.4.1 Pre-Processing

Executing the JRSS protocol as part of the JSG, IVG and SRG gates is time consuming since all participants 102 need to communicate for the distribution of shares associated with a value. In order to avoid such overhead, participants 102 can regularly precompute JRSS values that can be later used in the circuits. That is, the participants 102 can set up the JRSS valyes ahead of time, ready to be used when necessary. In terms of implementation, the computation of the JRSS values can be executed in parallel whilst evaluating a meta-circuit and each participant 102 can store a cache or database of unused shares associated to values. Once a share is used, the participant 102 deletes it from the database. Failure to delete the shares is not a security issue, but the participants 102 may start having a storage problem by saving too many shares.

### 4.4.2 SRG Delay

Inserting an SRG gate after each SecM multiplication gate may increase the number of JRSS values required. Take for example the function ƒ(x, y, a, b, c)=(ax+by)·c with x, y dealt inputs and a, b, c random inputs. This has three SecM gates and three corresponding SRG gates as in FIG. 5(i). To reduce the number of SRG gates, the coordinator 101 may instead insert only one SRG gate after we compute ax+by, before the multiplication by c and one SRG gate before we send the shares to the coordinator as seen in FIG. 4(ii). Further, the coordinator 101 may remove the last SRG gate and instead wait for 2t_{C}+1 shares.

To summarise, the step 3.d. of section 4.2 may be replaced by the following:
3.d. If an input to the SecM gate has threshold higher than t_{C}, insert an SRG gate between the input and the SecM gate.
3.e. If the coordinator 101 requires an output of threshold t_{C}, insert an SRG gate before the last reconstruction gate of the Meta-Circuit.

### 4.4.3 Maximum Threshold

Taking step 3.e. above further, we may let the threshold increase when computing the circuit until we reach a maximum acceptable threshold 2t_{C}≤tₘₐₓ<N. We replace steps 3.c. and 3.d. of section 4.2 as follows:
3.c. Replace each inverse gate for a non-scalar input with an IVG gate. If the input to the IVG gate has threshold t>tₘₐₓ−t_{C} then introduce an SRG gate between the input and the IVG gate.
3.d. If the expected output threshold of the SecM gate has threshold higher than tₘₐₓ insert an SRG gate between one of the inputs and the SecM gate. If the expected output threshold of the SecM gate is still higher than tₘₐₓ (e.g. when both inputs have high threshold) insert an additional SRG gate between the other input and the SecM gate.
3.e. If the coordinator 101 requires an output of threshold t_{C}, insert an SRG gate before the last reconstruction gate of the Meta-Circuit.

In the execution of the IVG gate, the input of threshold t is multiplied with a blinding share of threshold t_{C}, thus increasing the threshold to t+t_{C}. Because we require the threshold to be at most tₘₐₓ, then t+t_{C}≤tₘₐₓ and consequently t≤tₘₐₓ−t_{C}. Thus, whenever t>tₘₐₓ−t_{C} we need to reduce the threshold of the input using an SRG gate. This is captured by step 3.c.

### 4.5. Verifiability

Without verification of the meta-circuit, an attacker in a dishonest setting may inject an incorrect intermediate value at any point in the circuit to ensure that the final result output by the circuit is incorrect. Verification steps may be inserted into the process of circuit evaluation to prevent such attacks. We approach verification with the strategy of checking whether the computations done by the ETOM participants are correct with respect to the meta-circuit.

### 4.5.1 Verification Framework

We can think about the verification as two-layered. On the first layer, each party 102 computes each gate using their shares at, which is a private computation. On the second layer, each party 102 computes each gate using the obfuscated shares a G of other parties, which is a public computation. This is analogous to the fact that shares take a similar form to private keys, and the obfuscated shares are similar to public keys. The verification process compares the results of private computations with the results of the corresponding public computations.

Denote the obfuscated input associated with aᵢ by âᵢ such that if aᵢ corresponds to a share of the shared value a then âᵢ corresponds to a share of the shared value aG. As we will see later, it is not necessary for âᵢ to be equal to aᵢG.

### 4.5.2 Verification of Inputs

The first step towards a verifiable meta-circuit is to enable the verification of the SSG and JSG input gates. Assume β₀ is an input dealt by the coordinator, and ƒ(x)=β₀+β₁x+ . . . +Bₜ_{_{C}}x^{t}^{_{C}} is the associated polynomial. Each participant i receives a share aᵢ=ƒ(i) and the obsfucated shares of all other participants aⱼG.

### SSG Verification

The verification of the SSG gate is the following:
1. The coordinator broadcasts the obfuscated coefficients βₖG, k=0, . . . , t to all participants.
2. Each participant i verifies the inputs by checking the equality: âⱼ:=aⱼG=Σₖ₌₀^{t}j^{k}(βₖ G)=ƒ(j)G for all j=1, . . . , N.

### JSG Verification

To verify the JSG gate, each party executes the JVRSS scheme as part of the JSG gate, instead of JRSS. The steps of the JVRSS scheme are detailed in section 2.2.2. Furthermore, if β is a shared value of threshold t_{C} generated by JVRSS (through the JSG gate), then all parties can separately compute the obfuscated share:

$${\hat{β}}_{j} := {β}_{j} G = {\sum }_{i = 1}^{N} {\sum }_{l = 0}^{{t}_{C}} {j}^{l} ( {β}_{i , l} G ) , for all j = 1 , … , N$$

where β_{i,l}G are the obfuscated coefficients of the polynomial ƒᵢ(x)=β_{i,0}+β_{i,1}x+ . . . +β_{i,t}_{_{C}}x^{t}^{_{C}} of party i.

Other than the input gates (SSG, and JSG), the only other gates in the circuit that may require verification are the reconstruction gates. The reason is that each participant i needs to ensure that the shares used for interpolation in the reconstruction gates have been correctly computed by the corresponding participants.

By not verifying, an honest participant i risks that the output from the reconstruction gate, and any subsequent result using that output, is incorrect. The verification of reconstruction gates is a synchronisation point between the private and public computations, where the private outputs are compared to the public obfuscated outputs. FIG. 6 is an example of the verification of the reconstruction gate.

We now discuss public computations, whereby party i reproduces the computations of party j using obfuscated inputs.

### 4.5.3 Public Computation

We detail how the public computation (top strip in FIG. 6) is performed for different gates. Each gate in the meta-circuit has a corresponding public gate with inputs and outputs being obfuscated the obfuscated version of the shares used for private computations (bottom strip in FIG. 6).

### Additive Gates

To compute the additive gate, each party i has knowledge of the obfuscated inputs âⱼ and \hat{b}ⱼ of each party j=i, i+1, . . . , i+max(tₐ, t_{b}). Each party i computes the output ôⱼ=âⱼ+\hat{b}ⱼ for each corresponding j. A similar computation is performed for the ScaM gate.

### SecM Gates

Recall that for each party i the private computation of the SecM gate takes inputs aᵢ, bᵢ and returns an output of oᵢ=aᵢbᵢ. For the public computation, assume each party i also has knowledge of the obfuscated shares \hat{b}ⱼ of b, of threshold t_{b}. They execute the following steps:
1. Compute bG=ECint(\hat{b}ᵢ, \hat{b}ᵢ₊₁, . . . , \hat{b}ᵢ₊ₜ_{_{b}}), where ECint is the same as interpolate (i.e. Lagrange interpolation) except the modular summation is replaced by elliptic curve point addition.
2. Compute and broadcast the verification share ôᵢ:=aᵢbG.
3. Receive ôⱼ:=aⱼbG from each party j=i+1, . . . , i+tₐ.

The shares ôⱼ are the obfuscated output of the public computation of the SecM gate received from party j. Consequently the shares ôⱼ are the obfuscated inputs to the next gate in the public computation of the circuit.

### Reconstruction Gates

Whenever party i executes the reconstruction gate with obfuscated inputs ôⱼ, j=i, . . . , i+t_{ô} the public computation of the gate outputs ô=ECint(ôᵢ, ôᵢ₊₁, . . . , ôᵢ₊ₜ_{_{ô}}) Finally, we observe that because the SSG and JSG inputs have thresholds t_{C}, then tₐ and t_{b} can only have values t_{C} or 0 (when the input comes from a reconstruction gate).

### 4.5.4 Verification of RG Computation

Verification amounts to verifying the output o of the reconstruction gate against the obfuscated output ô of the corresponding public computation of the reconstruction gate.

We execute the following two steps:
1. Compute oG
2. Check whether oG [symbol] ô

As an example, assume oᵢ=aᵢ+bᵢ and bᵢ=cᵢdᵢ, where a, c, d are shared values of threshold t_{C}. Then the obfuscated share \hat{b}ᵢ is a verification share of threshold t_{C} computed by the SecM public computation. Thus, oᵢ has threshold 2t_{C}, whereas ôᵢ has threshold t_{C}. The shared values o and ô are computed through the reconstruction gate in the private and public computations respectively. Then, to complete the verification of the RG gate it is sufficient compare o and ô by checking whether oG=ô.

### 4.5.5 Circuit Verification

We have detailed how input gates (SSG and JSG gates) can be verified and how each individual reconstruction gate (RG) can be verified.

For readability we recall that obfuscated shares are of four different types, each computed through public computations:
JSG, SSG gates: \hat{β}ⱼ=βⱼG;
Additive gates: ôj=âⱼ+\hat{b}ⱼ;
ScaM gates: ôⱼ=kâⱼ, where k is a constant; and
SecM gates: ôⱼ=aⱼbG (also referred to as a ‘verification share’).

This allows us to define how the execution of a meta-circuit amongst a group of participants can be achieved in a fully-verifiable manner. Specifically, if verification of all input gates and all reconstruction gates is performed for a circuit, then the entire circuit execution can be considered a verifiable execution.

To ensure that all of the reconstruction gates can be verified, participants may perform public computations on all gates in the circuit. This ensures that any obfuscated shares ôj required as input for the public computation of RG will be available, and consequently that the verification of RG can be executed.

### 4.5.6—Example Verification—XOR

In order to clarify the verification protocol, we show how this can be done on the XOR circuit XOR(x, y)=(x−y)² and recall the circuit diagram as presented in section 4.3.2. We assume three ETOM parties and a threshold of t_{C}=1. We write the computational steps of the XOR Meta-Circuit from the perspective of each participant i=1, 2, 3 in the following way, giving the output of each gate:
G1. SSG gate: xᵢ
G2. SSG gate: yᵢ
G3. ScaM gate: cᵢ=(−1)yᵢ
G4. Additive gate: dᵢ=xᵢ+cᵢ
G5. SecM gate: eᵢ=dᵢdᵢ
SRG:
G6. JSG gate: βᵢ
G7. Additive gate: βᵢ=eᵢ+βᵢ
G8. Reconstruction gate: ƒ=e+β
G9. ScaM gate: gᵢ=(−1)βᵢ
G10. Additive gate: hᵢ=ƒ+gᵢ
G11. Reconstruction gate: h

The above meta-Circuit assumes an untrusted coordinator 101 that is not part of the computation and does not have access to the communication of the ETOM parties 102. Thus, the coordinator cannot deduce any intermediate private values from the computation of the parties. When the coordinator is part of the computation or has access to the communication of the ETOM parties, they can compute the value of e. In this case however, an SRG gate is unnecessary and can be removed to retain the security of the scheme. The SRG gate is introduced for coordinators that are not part of the computation so that they don't need to interpolate over more shares than t_{C}.

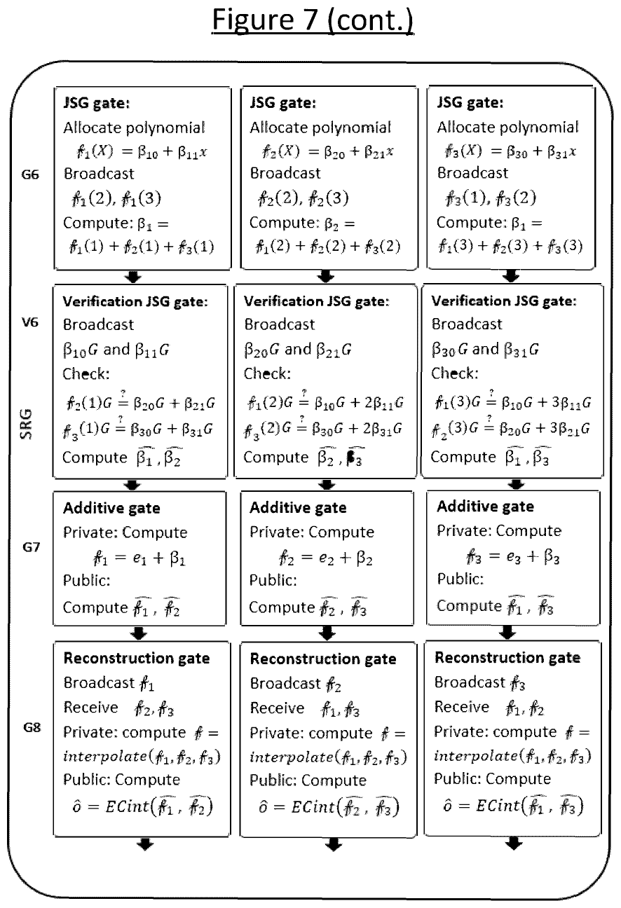

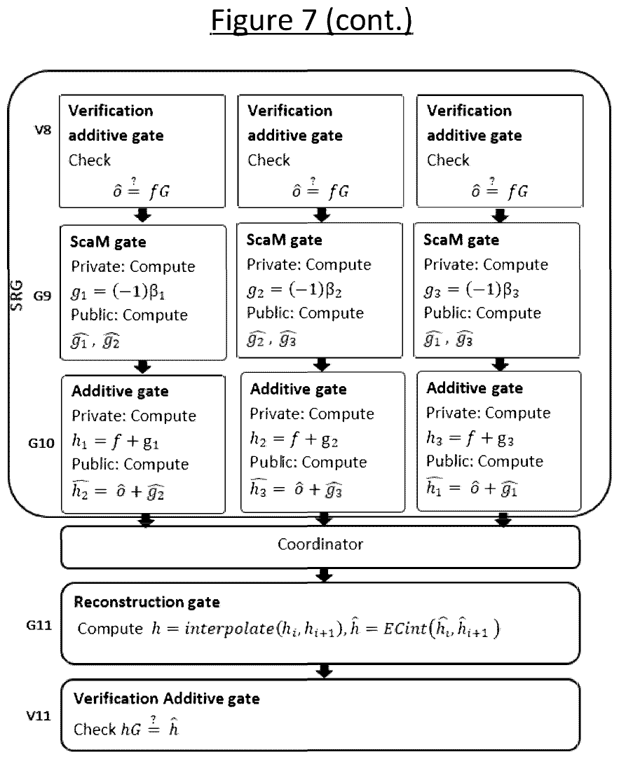

To introduce the verification of the above computation, we verify gates G1, G2, G6, G8, and G11. To see this more clearly, we can represent the computation with a flow diagram as given in FIG. 7.

In FIG. 7, we represent the multi-party execution of the XOR function in a scenario with a coordinator, who delegates the execution to a set of N=3 participants and with a circuit threshold t_{C}=1. The input values x, y are shared by the coordinator using degree-1 polynomials [symbol] (X)=x+αX, g(X)=y+δX, where α, δ∈_{R} [symbol] ₙ.

### 5. Example Use Case—Age Verification

In this section we present a use case that enables age verification: a customer can prove to a merchant they are at least 18 years old without revealing their age. This protects customer-sensitive data from being known by the merchant. This example shows how to implement a “less-than” operator using meta-circuits. Thus, being able to implement comparison operators can lead to more complex circuits.

We rely on Damgard's implementation of the “less-than” operator that takes as input two integers a, b expressed in bits and outputs whether a<b. Let â=(a₀, . . . , aₗ) and \hat{b}=(b₀, . . . bₗ) be the bitwise expansions of a and b expressed in big-endian format—a₁, bᵢ are the most significant bits. Then the function comparing a and b is:

```
LT(a₀, a₁, ... , aₗ, b0, ... , bₗ) {
  for i = 0, ... , l
  cᵢ ← aᵢ ⊕ bᵢ
  dₗ₊₁ ← 0, x ← 0
  for i = l, ... ,0
    dᵢ ← ∨ⱼ₌ᵢ^{l} cⱼ
    eᵢ ← dᵢ − dᵢ₊₁
    x ← x + eᵢ · bᵢ
  return x
}
```

where ⊕ is the XOR operator, V is the OR operator and Vⱼ₌ᵢ^{l}cⱼ=cᵢ∨cᵢ₊₁∨ . . . ∨cₗ. The function returns 1 when a<b and 0 if a≥b. For a and b to represent human ages, it is enough to take l=6, which allows for representation of values up to 127. In order to adapt the above algorithm for age verification, we take b=18 with its binary representation: \hat{b}=(0,1,0,0,1,0,0). Since the representation b is fixed, we optimise the LT function as follows:
1. We simplify the assignment of the array c based on the binary representation \hat{b}:
   c₀←a₀, c₁←1−a₁, c₂←a₂, c₃←a₃, c₄←1−a₄, c₅←a₅, c₆←a₆
2. There is no need to allocate an array c, as we can reuse the array a and reassign
   a₁←1−a₁, a₄+1−a₄.
3. The x simplifies to x=e₁+e₄, since only b₁ and b₄ are not 0.
4. Based on observation 3 above, it is enough to compute e₁←d₁−d₂ and e₄←d₄−d₅.
5. We note that

$${d}_{i} = {∨}_{j = i}^{l} {c}_{j} = {c}_{i} ⋁ {∨}_{j = i + 1}^{l} {c}_{j} = {c}_{i} ⋁ {d}_{i + 1}$$

Then dᵢ−dᵢ₊₁ can be rewritten as

$${c}_{i} ⋁ {d}_{i + 1} - {d}_{i + 1} = {d}_{i + 1} + {c}_{i} - {d}_{i + 1} {c}_{i} - {d}_{i + 1} = {c}_{i} ( 1 - {d}_{i + 1} ) ,$$

where we have used the identity:

$$α ⋁ β = α + β - α β .$$

Using the reassignments in observations 1 and 2, we get:

$${e}_{4} ← {c}_{4} ( 1 - {d}_{5} ) = {a}_{4} ( 1 - {a}_{5} ⋁ {a}_{6} ) and$$

$${e}_{1} ← {c}_{1} ( 1 - {d}_{2} ) = {a}_{1} ( 1 - {d}_{5} ⋁ {a}_{4} ⋁ {a}_{3} ⋁ {a}_{2} ) .$$

6. The least significant bit, do, is not used and does not have to be inputted.
7. Instead of returning x, the function should return 1−x=1−e₁−e₄ such that it outputs 1 in case a≥b and 0 otherwise.

The age verification function therefore reduces to the following:

```
age_verify(a₁, ... , a₆){
  a₁ ← 1 − a₁
  a₄ ← 1 − a₄
  d₅ ← a₅ ∨ a₆
  d₂ ← d₅ ∨ a₄ ∨ a₃ ∨ a₂
  return 1 − (a₁(1 − d₂) + a₄(1 −
d₅))
}
```

The function returns 1 if a≥18 and 0 otherwise. Before describing the meta-circuits and protocols, two examples are provided that prove that the function age_verify behaves as expected.

Case a=18.

The binary representation of a is (0,1,0,0,1,0,0). Then a₁=a₄=1 and a₀=a₁=a₂=a₃=a₅=a₆=0. After the execution of the first two lines of the function age_verify, we have: a₁=a₄=0.

Consequently, it immediately follows that line 3 and 4 of the function give d₅=d₂=0 and finally line 5 returns the value 1 which means that a≥18.

Case a=15.

The binary representation of a is (1,1,1,1,0,0,0). Then a₀=a₁=a₂=a₃=1 and a₄=a₅=a₆=0. After the execution of the first two lines, we have a₁=0 and a₄=1.

Moreover, line 3 gives d₅=0 and line 4 d₂=1. Then line 5 evalues to

$$1 - ( {a}_{1} ( 1 - {d}_{2} ) + {a}_{4} ( 1 - {d}_{5} ) ) = 1 - ( 0 + 1 \cdot 1 ) = 0.$$

Hence, because the function returns the value 0, we correctly evaluated that a<18.

### 5.1 Meta-Circuit Representation

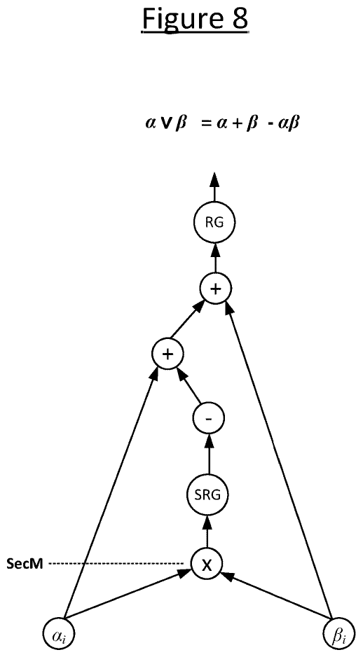

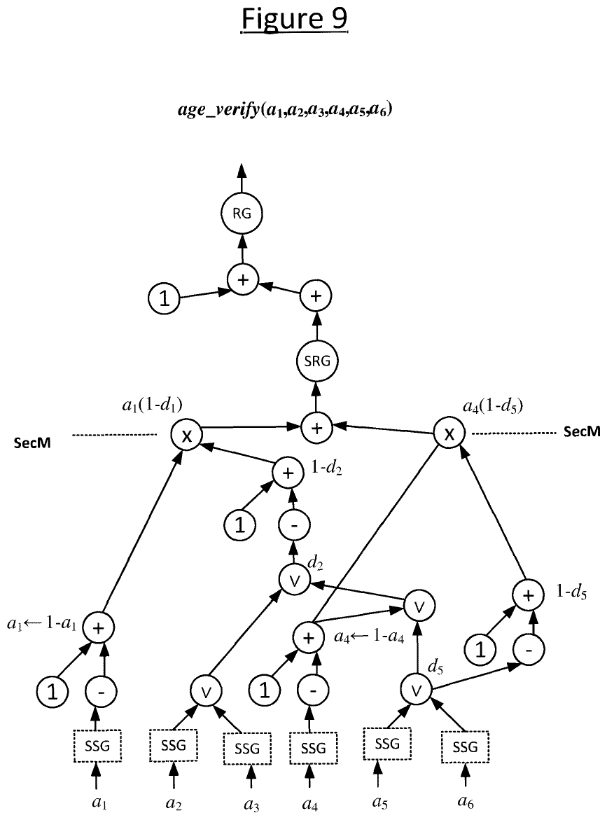

Using the arithmetic representation of the OR operator, the corresponding meta-circuit is constructed as shown in FIG. 8. Replacing each OR operator with its circuit representation, FIG. 9 expresses the full meta-circuit of the function age_verify. We detail the steps the customer and the ETOM parties execute to prove to the merchant that the customer is at least 18 years old. In this setting the customer is the coordinator 101. The protocol steps are the following:
1. The customer decomposes their age value a into the binary representation â=(a₀, a₁, . . . , a₆), and do can be discarded.
2. An SSG protocol is executed for each a₁, . . . , a₆ and the shares are distributed to ETOM parties.
3. All ETOM parties execute the Meta-Circuit of threshold t_{C} in FIG. 9 with inputs given by the shares.
4. In order to find whether the customer is above 18 years old, i.e. if a≥18, the merchant interpolates the outputs of the Meta-Circuit from at least t_{C}+1 ETOM parties through the reconstruction gate.

Notice that we do not perform SRG gate computation after each SecM gate, which can be expensive. To optimise, we delay the SRG gate computation, and this yields only one redistribution and threshold reduction.

### 5.2 Hardware Parallelisation

This section briefly discusses how we may achieve hardware parallelisation such that ETOM parties can quickly process the age verify function on their shares. For this we require that parties use FPGA boards. We will assume for exposition purposes that addition and multiplication are atomic operations and are not treated granularly at a hardware level. Moreover, we expand each V operation into addition and multiplication. Thus, age_verify as introduced in the above section has to execute 25 sequential operations, with 6 SecM gates being computed. This number can be computed by counting the non-SRG gates in FIG. 9 and expanding the V circuits with their representation as shown in FIG. 8. FPGA boards have several computational units that can be used to execute different tasks concurrently. We label each computational unit by CUᵢ, i=1, . . . , N_{CU} where N_{CU} is the number of units available on the board. Using this architecture, the execution we propose is the following:

$$1. In parallel : {CU}_{1} computes {m}_{1} = - {a}_{1} ,$$

$${CU}_{2} computes {m}_{2} = - {a}_{4} ,$$

$${CU}_{3} computes {m}_{3} = {a}_{3} + {a}_{2} ,$$

$${CU}_{4} computes {m}_{4} = {a}_{3} {a}_{2} ,$$

$${CU}_{5} computes {m}_{5} = - {a}_{6} + {a}_{5} ,$$

$${CU}_{6} computes {m}_{6} = - {a}_{6} {a}_{5} .$$

$$2. In parallel : {CU}_{1} computes {m}_{7} = 1 + {m}_{1} = {a}_{1} ← 1 - {a}_{1} ,$$

$${CU}_{2} computes {m}_{8} = 1 + {m}_{2} = {a}_{4} ← 1 - {a}_{4} ,$$

$${CU}_{4} computes {m}_{9} = - {m}_{4} = - {a}_{3} {a}_{2} ,$$

$${CU}_{6} computes {m}_{10} = - {m}_{6} = - {a}_{6} {a}_{5} .$$

$$3. In parallel : {CU}_{1} computes {m}_{11} = - {m}_{7} = {a}_{1} ,$$

$${CU}_{2} computes {m}_{12} = - {m}_{8} = {a}_{4} ,$$

$${CU}_{3} computes {m}_{13} = - {m}_{3} + {m}_{9} = {a}_{3} + {a}_{2} - {a}_{3} {a}_{2} = {a}_{3} ⋁ {a}_{2} ,$$

$${CU}_{5} computes {m}_{14} = {m}_{5} + {m}_{10} = {a}_{6} + {a}_{5} - {a}_{6} {a}_{5} = {a}_{6} ⋁ {a}_{5} = {d}_{5} .$$

$$4. In parallel : {CU}_{2} computes {m}_{15} = {m}_{8} + {m}_{14} = {a}_{4} + {a}_{6} ⋁ {a}_{5} ,$$

$${CU}_{3} computes {m}_{22} = - {m}_{13} = - {a}_{3} ⋁ {a}_{2} ,$$

$${CU}_{5} computes {m}_{16} = {m}_{8} {m}_{14} = {a}_{4} {d}_{5} ,$$

$${CU}_{6} computes {m}_{17} = {m}_{12} {m}_{14} = - {a}_{4} ( {a}_{6} ⋁ {a}_{5} ) .$$

$$5. In parallel : {CU}_{2} computes {m}_{18} = {m}_{15} + {m}_{17} = {a}_{4} + {a}_{6} ⋁ {a}_{5} - {a}_{4} ( {a}_{6} ⋁ {a}_{5} ) = {a}_{4} ⋁ {a}_{5} ⋁ {a}_{6} ,$$

$${CU}_{5} computes {m}_{19} = {m}_{12} + {m}_{16} = - {a}_{4} + {a}_{4} {d}_{5} = - {a}_{4} ( 1 - {d}_{5} ) .$$

$$6. In parallel : {CU}_{3} computes {m}_{20} = {m}_{13} + {m}_{18} = {a}_{3} ⋁ {a}_{2} + {a}_{4} ⋁ {a}_{5} ⋁ {a}_{6} ,$$

$${CU}_{2} computes {m}_{21} = {m}_{22} {m}_{18} = - ( {a}_{3} ⋁ {a}_{2} ) ( {a}_{4} ⋁ {a}_{5} ⋁ {a}_{6} ) .$$

$$7. {CU}_{3} computes {m}_{23} = {m}_{20} + {m}_{21} = {a}_{3} ⋁ {a}_{2} + {a}_{4} ⋁ {a}_{5} ⋁ {a}_{6} - ( {a}_{3} ⋁ {a}_{2} ) ( {a}_{4} ⋁ {a}_{5} ⋁ {a}_{6} ) = {a}_{2} ⋁ {a}_{3} ⋁ {a}_{4} ⋁ {a}_{5} ⋁ {a}_{6} = {d}_{2} .$$

$$8. {CU}_{3} computes {m}_{25} = {m}_{7} {m}_{23} = {a}_{1} {d}_{2}$$

$$9. In parallel : {CU}_{3} computes {m}_{26} = {m}_{11} + {m}_{25} = - {a}_{1} + {a}_{1} {d}_{2} = - {a}_{1} ( 1 - {d}_{2} ) ,$$

$${CU}_{5} computes {m}_{27} = 1 + {m}_{19} = 1 - {a}_{4} ( 1 - {d}_{5} )$$

$$10. {CU}_{3} computes {m}_{28} = {m}_{26} + {m}_{27} = 1 - ( {a}_{1} ( 1 - {d}_{2} ) + {a}_{4} ( 1 - {d}_{5} ) )$$

The algorithm reduces the processing from 25 to 10 sequential computations. In addition to reducing the number of sequential steps by 60%, this approach can have a significant impact in practice. The SecM multiplication gates increase the threshold and SRG gates need to be introduced to lower it, whereas addition and scalar multiplication do not have any computational overhead. The parallelised solution reduces the number of sequential multiplications (SecM gates) from 6 to only 4 (steps 1, 4, 6 and 8).

Note that the hardware fingerprint (measured in number of computational units used) is low, with only 6 computational units needed at its highest load (step 1).

A further optimisation may be implemented: the circuit can execute in 9 sequential steps by computing a₁d₂ more granularly, however this increases the number of sequential multiplications. This can be implemented if there are enough number of participants such that we do not have to add many SRG gates to reduce the threshold.

### 6. Further Remarks

Other variants or use cases of the disclosed techniques may become apparent to the person skilled in the art once given the disclosure herein. The scope of the disclosure is not limited by the described embodiments but only by the accompanying claims.

It will be appreciated that the above embodiments have been described by way of example only. More generally there may be provided a method, apparatus or program in accordance with any one or more of the following Statements.
Statement 1. A computer-implemented method for performing a multi-party computation (MPC) protocol, wherein a group comprises a coordinator and a plurality of parties, and wherein the method is performed by the coordinator and comprises:
   obtaining a circuit representation of a computable function to be evaluated based on one or more first inputs to generate one or more outputs, wherein each first input is to be either specified or randomly generated, and wherein the circuit representation comprises a) a plurality of arithmetic gates representing respective functions for operating on one or more of the first inputs and/or or one or more second inputs, wherein a second input is a respective output of a respective gate, and b) a plurality of directed edges, wherein each directed edge represents a first or second input being supplied to a respective arithmetic gate to be operated on by that respective arithmetic gate;
   converting the circuit representation of the function to a multi-party representation of the function by:
      replacing each specified first input with a respective first splitting gate (SSG), wherein each respective SSG represents a protocol performed by the coordinator to distribute a respective share of a respective secret to each respective party, wherein the respective secret is associated with a respective threshold;
      replacing each randomly generated first input with a respective second splitting gate (JSG), wherein each respective JSG gate represents a protocol performed by each party to collaboratively generate a respective share of a respective secret, wherein the respective secret is associated with a respective threshold;
   making the multi-party representation available to each party, wherein each party is configured to evaluate the function by executing the multi-party representation based on their respective shares of the respective secrets, thereby generating a respective share of each output;
   executing each SSG by distributing the respective share of the respective secret to each respective party;
   obtaining a respective share of each output from at least a threshold number of parties, the threshold number corresponding to a circuit threshold associated with the multi-party circuit; and
   generating each output of the function, wherein each output is generated based on at least the threshold number of the respective output shares of that output.
Statement 2. The method of statement 1, wherein the multi-party circuit representation comprises, for each output to be generated, a respective reconstruction gate (RG), and wherein each respective RG gate represents a protocol performed by the coordinator to generate a respective output by interpolating over the respective output shares that are input to the respective RG.
Statement 3. The method of statement 1 or statement 2, wherein the circuit representation comprises one or more inverse gates representing a function configured to output a respective inverse of a respective non-scalar input, and wherein said converting comprises:
   replacing each of said one or more inverse gates with a respective share inverse gate (IVG), wherein each respective IVG represents a protocol performed by each party to collaboratively generate a respective inverse share of a respective share that is input to the IVG.
Statement 4. The method of any preceding statement, wherein the circuit representation comprises one or more share multiplication (SecM) gates, where each respective SecM gate represents a function configured to multiply two respective shares input to the SecM gate and output a result of the multiplication to a respective next gate in the multi-party circuit representation, and wherein said converting comprises:
   inserting a respective share-redistribution gate (SRG) between each respective SecM gate and the respective next gate, wherein each respective SRG represents a protocol performed by each party to collaboratively generate a new respective share of a respective shared value input to the respective SRG, wherein the new respective share is associated with the circuit threshold, whereas the respective shared value is associated with a higher threshold.
Statement 5. The method of statement 2 or statement 3 when dependent on statement 2, wherein the circuit representation comprises one or more share multiplication (SecM) gates, where each respective SecM gate represents a function configured to multiply two respective shares input to the SecM gate and output a result of the multiplication to a respective next gate in the multi-party circuit representation, and wherein said converting comprises:
   if the respective share that is input to a respective SecM gate has a threshold higher than the threshold of the respective secrets, inserting a respective share-redistribution gate (SRG) between the respective SecM gate and the respective previous gate, wherein each respective SRG represents a protocol performed by each party to collaboratively generate a new respective share of a respective shared value input to the respective SRG, wherein the new respective share is associated with the circuit threshold, whereas the respective shared value is associated with a higher threshold; and
   inserting a respective SRG before each respective RG gate for each output to be generated.
Statement 6. The method of statement 2 and statement 3, wherein the multi-party circuit has a maximum threshold 2t_{C}≤tₘₐₓ<N, where N is the number of parties in the group and t_{C} is the threshold of the respective secrets, wherein the circuit representation comprises one or more share multiplication (SecM) gates, where each respective SecM gate represents a function configured to multiply two respective shares input to the SecM gate and output a result of the multiplication to a respective next gate in the multi-party circuit representation, and wherein said converting comprises:
   if the respective share that is input to the respective IVG has a threshold t>tₘₐₓ−t_{C}, inserting a respective share-redistribution gate (SRG) between each respective IVG gate and the respective previous gate, wherein each respective SRG represents a protocol performed by each party to collaboratively generate a new respective share of a respective shared value input to the respective SRG, wherein the new respective share is associated with the circuit threshold, whereas the respective shared value is associated with a higher threshold;
   if an expected output threshold of the respective share output by a respective SecM gate is higher than tₘₐₓ, inserting an SRG between one or both of the respective shares that are input to respective the SecM gate and the respective SecM gate; and
   inserting a respective SRG before each respective RG gate for each output to be generated.
Statement 7. The method of any preceding statement, wherein the protocol performed by the coordinator to distribute a respective share of the respective secret to each respective party comprises Shamir's secret sharing scheme (SSSS).
Statement 8. The method of any preceding statement, wherein the protocol performed by each party to collaboratively generate a respective share of the respective secret comprises a joint random secret sharing scheme (JRSS) or a joint verifiable random secret sharing scheme (JVRSS).
Statement 9. The method of any preceding statement, wherein obtaining the circuit representation of the function comprises generating the circuit representation.
Statement 10. The method of any preceding statement, comprising:
   for each respective secret generated by the coordinator, sending obfuscated coefficients of a corresponding respective polynomial to each party for verifying the respective secret.
Statement 11. The method of any preceding statement, wherein the computable function is an ECSDA signature-generating function. The signature-generating function may be ECDSA.
Statement 12. The method of any preceding statement, wherein the computable function is an age verification function.
Statement 13. The method of any preceding statement, wherein the coordinator is one of the parties.
Statement 14. A computer-implemented method of performing a multi-party computation (MPC) protocol, wherein a group comprises a coordinator and a plurality of parties, and wherein the method is performed by a first one of the parties and comprises:
   obtaining a multi-party circuit representation of a computable function converted from a circuit representation of the function, wherein the function is to be evaluated based on one or more first inputs to generate one or more outputs, wherein each first input is to be either specified or randomly generated, and wherein the circuit representation comprises a) a plurality of arithmetic gates representing respective functions for operating on one or more of the first inputs and/or or one or more second inputs, wherein a second input is a respective output of a respective gate, and b) a plurality of directed edges, wherein each directed edge represents a first or second input being supplied to a respective arithmetic gate to be operated on by that respective arithmetic gate, and wherein the multi-party circuit is generated by:
      replacing each specified first input with a respective first splitting gate (SSG), wherein each respective SSG represents a protocol performed by the coordinator to distribute a respective share of a respective secret to each respective party, wherein the respective secret is associated with a respective threshold; and
      replacing each randomly generated first input with a respective second splitting gate (JSG), wherein each respective JSG gate represents a protocol performed by each party to collaboratively generate a respective share of a respective secret, wherein the respective secret is associated with a respective threshold;
   evaluating the function by executing the multi-party circuit representation based on a first respective share of each respective secret to generate a first respective share of each output; and
   sending the first respective share of each output to the coordinator, wherein the coordinator is configured to obtain a respective share of each output from at least a threshold number of parties, the threshold number corresponding to the circuit threshold, and to generate each output of the function, wherein each output is generated based on at least the threshold number of the respective output shares of that output.
Statement 15. The method of statement 14, wherein the protocol performed by each party to collaboratively generate a respective share of the respective secret comprises a joint random secret sharing scheme (JRSS) or a joint verifiable secret sharing scheme (JVRSS), and wherein the method comprises using JRSS or JVRSS to generate a first respective share of one or more of the respective secrets.
Statement 16. The method of statement 14 or statement 15, wherein the protocol performed by the coordinator to distribute a respective share of the respective secret to each respective party comprises Shamir's secret sharing scheme (SSSS), and wherein the method comprises receiving a first respective share of one or more of the respective secrets generated using SSSS.
Statement 17. The method of any of statements 14 to 16, comprising:
   for each respective secret generated by the coordinator, receiving from the coordinator obfuscated coefficients of a corresponding respective polynomial; and
   verifying the respective secret based on the obfuscated coefficients.
Statement 18. The method of any of statement 14 to 16, comprising, for each other party:
   receiving respective obfuscated shares of the respective secrets and executing the multi-party circuit representation based on the respective obfuscated shares of the respective secrets to generate a respective obfuscated share of each output;
   receiving a respective candidate obfuscated share of each output; and
   verifying the respective candidate obfuscated share of each output corresponds to the generated respective obfuscated share of that output.
Statement 19. The method of any of statements 14 to 18, wherein said obtaining of the multi-party circuit representation comprises receiving the multi-party circuit representation from the coordinator.
Statement 20. The method of any of statements 14 to 18, wherein said obtaining of the multi-party circuit representation comprises generating the multi-party circuit representation.
Statement 21. The method of any of statements 14 to 20, wherein the coordinator is one of the parties.
Statement 22. Computer equipment comprising:
   memory comprising one or more memory units; and
   processing apparatus comprising one or more processing units, wherein the memory stores code arranged to run on the processing apparatus, the code being configured so as when on the processing apparatus to perform the method of any of statements 1 to 21.
Statement 23. A computer program embodied on computer-readable storage and configured so as, when run on one or more processors, to perform the method of any of statements 1 to 21.

According to another aspect disclosed herein, there may be provided a method comprising the actions of the coordinator and the plurality of parties.

According to another aspect disclosed herein, there may be provided a system comprising the computer equipment of the coordinator and the plurality of parties.

1. A computer-implemented method for performing a multi-party computation (MPC) protocol, wherein a group comprises a coordinator and a plurality of parties, and wherein the method is performed by the coordinator and comprises:
obtaining a circuit representation of a computable function to be evaluated based on one or more first inputs to generate one or more outputs, wherein each first input is to be either specified or randomly generated, and wherein the circuit representation comprises a) a plurality of arithmetic gates representing respective functions for operating on one or more of the first inputs and/or or one or more second inputs, wherein a second input is a respective output of a respective gate, and b) a plurality of directed edges, wherein each directed edge represents a first or second input being supplied to a respective arithmetic gate to be operated on by that respective arithmetic gate;
converting the circuit representation of the function to a multi-party representation of the function by:
replacing each specified first input with a respective first splitting gate (SSG), wherein each respective SSG represents a protocol performed by the coordinator to distribute a respective share of a respective secret to each respective party, wherein the respective secret is associated with a respective threshold;
replacing each randomly generated first input with a respective second splitting gate (JSG), wherein each respective JSG gate represents a protocol performed by each party to collaboratively generate a respective share of a respective secret, wherein the respective secret is associated with a respective threshold;
making the multi-party representation available to each party, wherein each party is configured to evaluate the function by executing the multi-party representation based on their respective shares of the respective secrets, thereby generating a respective share of each output;
executing each SSG by distributing the respective share of the respective secret to each respective party;
obtaining a respective share of each output from at least a threshold number of parties, the threshold number corresponding to a circuit threshold associated with the multi-party circuit; and
generating each output of the function, wherein each output is generated based on at least the threshold number of the respective output shares of that output.

2. The method of claim 1, wherein the multi-party circuit representation comprises, for each output to be generated, a respective reconstruction gate (RG), and wherein each respective RG gate represents a protocol performed by the coordinator to generate a respective output by interpolating over the respective output shares that are input to the respective RG.

3. The method of claim 1, wherein the circuit representation comprises one or more inverse gates representing a function configured to output a respective inverse of a respective non-scalar input, and wherein said converting comprises:
replacing each of said one or more inverse gates with a respective share inverse gate (IVG), wherein each respective IVG represents a protocol performed by each party to collaboratively generate a respective inverse share of a respective share that is input to the IVG.

4. The method of claim 1, wherein the circuit representation comprises one or more share multiplication (SecM) gates, where each respective SecM gate represents a function configured to multiply two respective shares input to the SecM gate and output a result of the multiplication to a respective next gate in the multi-party circuit representation, and wherein said converting comprises:
inserting a respective share-redistribution gate (SRG) between each respective SecM gate and the respective next gate, wherein each respective SRG represents a protocol performed by each party to collaboratively generate a new respective share of a respective shared value input to the respective SRG, wherein the new respective share is associated with the circuit threshold, whereas the respective shared value is associated with a higher threshold.

5. The method of claim 2, wherein the circuit representation comprises one or more share multiplication (SecM) gates, where each respective SecM gate represents a function configured to multiply two respective shares input to the SecM gate and output a result of the multiplication to a respective next gate in the multi-party circuit representation, and wherein said converting comprises:
if the respective share that is input to a respective SecM gate has a threshold higher than the threshold of the respective secrets, inserting a respective share-redistribution gate (SRG) between the respective SecM gate and the respective previous gate, wherein each respective SRG represents a protocol performed by each party to collaboratively generate a new respective share of a respective shared value input to the respective SRG, wherein the new respective share is associated with the circuit threshold, whereas the respective shared value is associated with a higher threshold; and
inserting a respective SRG before each respective RG gate for each output to be generated.

6. The method of claim 2, wherein the circuit representation comprises one or more inverse gates representing a function configured to output a respective inverse of a respective non-scalar input, and wherein said converting comprises: replacing each of said one or more inverse gates with a respective share inverse gate (IVG), wherein each respective IVG represents a protocol performed by each party to collaboratively generate a respective inverse share of a respective share that is input to the IVG; wherein the multi-party circuit has a maximum threshold 2t_{C}≤tₘₐₓ<N, where N is the number of parties in the group and t_{C} is the threshold of the respective secrets, wherein the circuit representation comprises one or more share multiplication (SecM) gates, where each respective SecM gate represents a function configured to multiply two respective shares input to the SecM gate and output a result of the multiplication to a respective next gate in the multi-party circuit representation, and wherein said converting comprises:
if the respective share that is input to the respective IVG has a threshold t>tₘₐₓ−t_{C}, inserting a respective share-redistribution gate (SRG) between each respective IVG gate and the respective previous gate, wherein each respective SRG represents a protocol performed by each party to collaboratively generate a new respective share of a respective shared value input to the respective SRG, wherein the new respective share is associated with the circuit threshold, whereas the respective shared value is associated with a higher threshold;
if an expected output threshold of the respective share output by a respective SecM gate is higher than tₘₐₓ, inserting an SRG between one or both of the respective shares that are input to respective the SecM gate and the respective SecM gate; and
inserting a respective SRG before each respective RG gate for each output to be generated.

7. The method of claim 1, wherein the protocol performed by the coordinator to distribute a respective share of the respective secret to each respective party comprises Shamir's secret sharing scheme (SSSS).

8. The method of claim 1, wherein the protocol performed by each party to collaboratively generate a respective share of the respective secret comprises a joint random secret sharing scheme (JRSS) or a joint verifiable random secret sharing scheme (JVRSS).

9. The method of claim 1, wherein obtaining the circuit representation of the function comprises generating the circuit representation.

10. The method of claim 1, comprising:
for each respective secret generated by the coordinator, sending obfuscated coefficients of a corresponding respective polynomial to each party for verifying the respective secret.

11. The method of claim 1, wherein the computable function is an ECSDA signature-generating function.

12. The method of claim 1, wherein the computable function is an age verification function.

13. The method of claim 1, wherein the coordinator is one of the parties.

14. A computer-implemented method of performing a multi-party computation (MPC) protocol, wherein a group comprises a coordinator and a plurality of parties, and wherein the method is performed by a first one of the parties and comprises:
obtaining a multi-party circuit representation of a computable function converted from a circuit representation of the function, wherein the function is to be evaluated based on one or more first inputs to generate one or more outputs, wherein each first input is to be either specified or randomly generated, and wherein the circuit representation comprises a) a plurality of arithmetic gates representing respective functions for operating on one or more of the first inputs and/or or one or more second inputs, wherein a second input is a respective output of a respective gate, and b) a plurality of directed edges, wherein each directed edge represents a first or second input being supplied to a respective arithmetic gate to be operated on by that respective arithmetic gate, and wherein the multi-party circuit is generated by:
replacing each specified first input with a respective first splitting gate (SSG), wherein each respective SSG represents a protocol performed by the coordinator to distribute a respective share of a respective secret to each respective party, wherein the respective secret is associated with a respective threshold; and
replacing each randomly generated first input with a respective second splitting gate (JSG), wherein each respective JSG gate represents a protocol performed by each party to collaboratively generate a respective share of a respective secret, wherein the respective secret is associated with a respective threshold;
evaluating the function by executing the multi-party circuit representation based on a first respective share of each respective secret to generate a first respective share of each output; and
sending the first respective share of each output to the coordinator, wherein the coordinator is configured to obtain a respective share of each output from at least a threshold number of parties, the threshold number corresponding to a circuit threshold, and to generate each output of the function, wherein each output is generated based on at least the threshold number of the respective output shares of that output.

15. The method of claim 14, wherein the protocol performed by each party to collaboratively generate a respective share of the respective secret comprises a joint random secret sharing scheme (JRSS) or a joint verifiable secret sharing scheme (JVRSS), and wherein the method comprises using JRSS or JVRSS to generate a first respective share of one or more of the respective secrets.

16. The method of claim 14, wherein the protocol performed by the coordinator to distribute a respective share of the respective secret to each respective party comprises Shamir's secret sharing scheme (SSSS), and wherein the method comprises receiving a first respective share of one or more of the respective secrets generated using SSSS.

17. The method of claim 14, comprising:
for each respective secret generated by the coordinator, receiving from the coordinator obfuscated coefficients of a corresponding respective polynomial; and
verifying the respective secret based on the obfuscated coefficients.

18. The method of claim 14, comprising, for each other party:
receiving respective obfuscated shares of the respective secrets and executing the multi-party circuit representation based on the respective obfuscated shares of the respective secrets to generate a respective obfuscated share of each output;
receiving a respective candidate obfuscated share of each output; and
verifying the respective candidate obfuscated share of each output corresponds to the generated respective obfuscated share of that output.

19-22. (canceled)

23. A computer program product embodied on non-transitory computer-readable storage media and configured so as, when run on one or more processors of a coordinator of a group comprising the coordinator and a plurality of parties, the one or more processors perform a method for performing a multi-party computation (MPC) protocol, the method comprising:
obtaining a circuit representation of a computable function to be evaluated based on one or more first inputs to generate one or more outputs, wherein each first input is to be either specified or randomly generated, and wherein the circuit representation comprises a) a plurality of arithmetic gates representing respective functions for operating on one or more of the first inputs and/or or one or more second inputs, wherein a second input is a respective output of a respective gate, and b) a plurality of directed edges, wherein each directed edge represents a first or second input being supplied to a respective arithmetic gate to be operated on by that respective arithmetic gate;
converting the circuit representation of the function to a multi-party representation of the function by:
replacing each specified first input with a respective first splitting gate (SSG), wherein each respective SSG represents a protocol performed by the coordinator to distribute a respective share of a respective secret to each respective party, wherein the respective secret is associated with a respective threshold;
replacing each randomly generated first input with a respective second splitting gate (JSG), wherein each respective JSG gate represents a protocol performed by each party to collaboratively generate a respective share of a respective secret, wherein the respective secret is associated with a respective threshold;
making the multi-party representation available to each party, wherein each party is configured to evaluate the function by executing the multi-party representation based on their respective shares of the respective secrets, thereby generating a respective share of each output;
executing each SSG by distributing the respective share of the respective secret to each respective party;
obtaining a respective share of each output from at least a threshold number of parties, the threshold number corresponding to a circuit threshold associated with the multi-party circuit; and
generating each output of the function, wherein each output is generated based on at least the threshold number of the respective output shares of that output.

24. A computer program embodied on computer-readable storage and configured so as, when run on one or more processors of a first party of a plurality of parties of a group comprising a coordinator and the plurality of parties, to perform a method of performing a multi-party computation (MPC) protocol, wherein the method comprises:
obtaining a multi-party circuit representation of a computable function converted from a circuit representation of the function, wherein the function is to be evaluated based on one or more first inputs to generate one or more outputs, wherein each first input is to be either specified or randomly generated, and wherein the circuit representation comprises a) a plurality of arithmetic gates representing respective functions for operating on one or more of the first inputs and/or or one or more second inputs, wherein a second input is a respective output of a respective gate, and b) a plurality of directed edges, wherein each directed edge represents a first or second input being supplied to a respective arithmetic gate to be operated on by that respective arithmetic gate, and wherein the multi-party circuit is generated by:
replacing each specified first input with a respective first splitting gate (SSG), wherein each respective SSG represents a protocol performed by the coordinator to distribute a respective share of a respective secret to each respective party, wherein the respective secret is associated with a respective threshold; and
replacing each randomly generated first input with a respective second splitting gate (JSG), wherein each respective JSG gate represents a protocol performed by each party to collaboratively generate a respective share of a respective secret, wherein the respective secret is associated with a respective threshold;
evaluating the function by executing the multi-party circuit representation based on a first respective share of each respective secret to generate a first respective share of each output; and
sending the first respective share of each output to the coordinator, wherein the coordinator is configured to obtain a respective share of each output from at least a threshold number of parties, the threshold number corresponding to a circuit threshold, and to generate each output of the function, wherein each output is generated based on at least the threshold number of the respective output shares of that output.
